(19) United States
(12) Patent Application Publication
(10) Pub. No.: US 2012/0281436 A1
(43) Pub. Date: Nov. 8, 2012

(54) ISOLATED DC-TO-DC VOLTAGE STEP-UP CONVERTER

(75) Inventor: SLOBODAN CUK, Laguna Niguel, CA (US)

(73) Assignee: CUKS, LLC

(21) Appl. No.: 13/101,971

(22) Filed: May 5, 2011

(51) Int. Cl. H02M 3/335

(52) U.S. Cl. 363/21.03

(57) ABSTRACT

An isolated DC-to-DC voltage step-up converter is provided with four switches, an input inductor, an isolation transformer, two resonant inductors and two resonant capacitors and operates with two distinct intervals: ON-time interval and an OFF-time interval. The two half-wave sinusoidal resonant capacitor charge and discharge intervals, one during the ON-time interval and the other during the OFF-time interval are chosen as to eliminate the losses due to energy stored in the leakage inductance of the isolation transformer and to operates with zero voltage switching of the primary side switches. It provides the output voltage regulation over the wide input voltage range with the same low voltage stresses of all four switching devices. The isolation transformer has full bi-directional flux capability and has DC bias. Despite the two independently controlled resonances, the output voltage is controlled by the duty ratio D control at constant switching frequency.

### FIELD OF THE INVENTION

The non-isolated switching DC-to-DC converters (1) can be broadly divided into three basic categories based on their controlling duty ratio D input to output DC voltage conversion characteristics : a) step-down only (buck converter), step-up only (boost converter) and step down/step-up (flyback, SEPIC, and Cuk converters). This invention relates to the step-up class of switching DC-to-DC power converters by providing not only polarity non-inverting converter topology (positive input to positive output converter voltage) such as ordinary boost converter but also having a polarity inverting topology capable of generating a negative output voltage from the positive input voltage heretofore not available in present step-up (boost) switching converters.

Another classification can be made with respect to the converters ability to have a galvanically isolated version. The present invention also belongs to this class of converters with voltage step-up gain and inclusion of the isolation transformer.

Another classifications of switching DC-to-DC converters can be made relative to the number of switches used. The present invention belongs to the category of converters, which have four switches.

### DEFINITIONS AND CLASSIFICATIONS

The following notation is consistently used throughout this text in order to facilitate easier delineation between various quantities:
1. DC—Shorthand notation historically referring to Direct Current but by now has acquired wider meaning and refers generically to circuits with DC quantities;
2. AC—Shorthand notation historically referring to Alternating Current but by now has acquired wider meaning and refers to all Alternating electrical quantities (current and voltage);
3. i₁, v₂—The instantaneous time domain quantities are marked with lower case letters, such as i₁ and v₂ for current and voltage;
4. I₁, V₂—The DC components of the instantaneous periodic time domain quantities are designated with corresponding capital letters, such as I₁ and V₂;
5. Δv—The AC ripple voltage on energy transferring capacitor C;
6. f_{S}—Switching frequency of converter;
7. T_{S}—Switching period of converter inversely proportional to switching frequency f_{S};
8. T_{ON}—ON-time interval T_{ON}=DT_{S} during which switch S₁ is turned ON;
9. T_{OFF}—OFF-time interval T_{OFF}=D′T_{S} during which switch S₂ is turned ON;
10. D—Duty ratio of the main controlling switch S₁;
11. D′—Complementary duty ratio D′=1−D of the main controlling switch S₁;
12. fᵣ₁—First resonant frequency defined by first resonant inductor Lᵣ₁ and equivalent resonant capacitor Cᵣ;
13. fᵣ₂—Second resonant frequency defined by second resonant inductor Lᵣ₂ and equivalent resonant capacitor Cᵣ;
14. tᵣ₁—Resonant period defined as tᵣ₁=1/fᵣ₁;
15. T_{R1}—One half of resonant period tᵣ₁;
16. tᵣ₂—Resonant period defined as tᵣ₂=1/fᵣ₂;
17. T_{R2}—One half of resonant period tᵣ₂;
18. S₁—First controllable switch with two switch states: ON and OFF;
19. S₂—Second controllable switch with two switch states: ON and OFF which are out of phase with switch states of switch S₁
20. CR₁—Two-terminal Current Rectifier whose ON and OFF states depend on S₁ switch states and circuit conditions.
21. CR₂—Two-terminal Current Rectifier whose ON and OFF states depend on S₂ switch states and circuit conditions.

### BRIEF DESCRIPTION OF THE DRAWINGS

FIG. 1a is a prior-art boost converter, FIG. 1b are the switch states for the boost converter of FIG. 1a, and FIG. 1c illustrates DC voltage gain for boost converter of FIG. 1a

FIG. 2a illustrates voltage stresses of the boost converter, and FIG. 2b illustrates the flux/turn of the inductor of the boost converters of FIG. 1a as a function of duty ratio D.

FIG. 3a is schematic of the prior-art Isolated Full-Bridge Boost converter and FIG. 3b is the state of the switches for the converter of FIG. 3a.

FIG. 4a illustrates the schematic of the prior-art Isolated boost push-pull converter and

FIG. 4b are the switch states for the converter in FIG. 4a.

FIG. 5a illustrates the prior-art, single ended isolated boost converter, FIG. 5b illustrates the states of the four switches and FIG. 5c is the graph of voltage stresses of the switches.

FIG. 6a illustrates the two-stage prior-art solution with boost converter followed by a half bridge primary center-tap secondary fixed conversion ratio converter operated with 50% duty ratio of the switches. FIG. 6b illustrates another two-stage prior-art solution with boost converter followed by a half bridge primary, full bridge secondary fixed conversion ratio converter operated with 50% duty ratio of the switches.

FIG. 7a illustrates the first embodiment of present invention, FIG. 7b the state of the switches and FIG. 7c the DC voltage gain of the converter in FIG. 7a.

FIG. 8a is a schematic of the non-isolated embodiment of the converter in FIG. 7a, FIG. 8b is a part of converter generating step-up conversion gain and FIG. 8c is a resonant converter part having a unity DC gain.

FIG. 9a illustrates a voltage on the input inductor of converter in FIG. 8a, FIG. 9b is a inductor current waveform and FIG. 9c is the switch S₂ current of the converter in FIG. 8b.

FIG. 10a illustrates the switch states for the converter in FIG. 8a, FIG. 10b shows the resonant capacitor current waveform and FIG. 10c shows the input and output currents of the resonant converter in FIG. 8c.

FIG. 11a shows the MOSFET transistor implementation of the converter in FIG. 8a and FIG. 11b shows the resonant current and input inductor current for duty ratio D=0.33.

FIG. 12a illustrates a resonant capacitor Cᵣ current and inductor current for D=0.5 and FIG. 12b illustrates resonant capacitor Cᵣ current and inductor current for D=0.66.

FIG. 13a illustrate a resonant capacitor Cᵣ current (third trace from top) and input inductor current (fourth trace from top) obtained on an experimental prototype for D=0.33, FIG. 13b the same waveforms recorded for D=0.5

FIG. 14a shows the same waveforms as in FIG. 13b but recorded for D=0.66. FIG. 14b illustrates as a second trace from the top the composite switch current, which is a sum of the switch currents for switches S₁ and S₂ for duty ratio D=0.33,

FIG. 15a shows the same waveforms for duty ratio D=0.5 and FIG. 15b shows the same waveforms for D=0.66.

FIG. 16a illustrates the equivalent circuit model for ON-time interval and FIG. 16b equivalent circuit model for OFF-time interval for the converter of FIG. 11a and FIG. 16c illustrates the simplified circuit model for ON-time interval and FIG. 16d illustrates a simplified circuit model for OFF-time interval.

FIG. 17a illustrates the final resonant circuit model for the special case of two resonant intervals being equal to half a switching period, FIG. 17b illustrates the resonant capacitor current and FIG. 17c illustrates the resonant capacitor voltage v_{Cr} for the converter of FIG. 11a.

FIG. 18a is a circuit model for the first resonant conduction period and FIG. 18b is a circuit model for the second resonant conduction period for the converter in FIG. 8a and FIG. 18c illustrates the resonant capacitor current in this general case.

FIG. 19a illustrates the polarity inverting converter embodiment with the sindle resonant inductor Lᵣ in the branch with the resonant capacitor Cᵣ; FIG. 19b shows the switch states, and FIG. 19c illustrates the capacitor resonant current.

FIG. 20a is circuit model for ON-time interval and FIG. 20b is a circuit model for OFF-time interval for converter in FIG. 19a, and FIG. 20c and FIG. 20d are their simplified circuit models.

FIG. 21a is a resonant circuit model for the special case output capacitor C and boost capacitor C_{b} capacitor are much larger then the resonant capacitor Cᵣ. FIG. 21b is a resonant capacitor current for the special case when resonant interval is adjusted to half the switching period and FIG. 21c is a resonant capacitor voltage for the special case when resonant interval is adjusted to half the switching period.

FIG. 22a is a circuit model for OFF-time interval displaying voltage stresses on switches, FIG. 22b is a circuit model for ON-time interval displaying voltage stresses of all switches and FIG. 22c is a graph of voltage stresses of all switches as a function of duty ratio D.

FIG. 23a is a graph of the DC voltage gain of the converter in FIG. 7a and FIG. 23b illustrates the resonant capacitor current waveform when duty ratio D is smaller than resonant duty ratio D_{R}.

FIG. 24a illustrates the experimental resonant capacitor current (second trace from top) and input inductor current (fourth trace from top) for duty ratio D smaller then D_{R}. and FIG. 24b illustrates the case when duty ratio is further reduced. FIG. 25a illustrates the salient waveforms when the duty ratio D=0.66 and FIG. 25b illustrates the case when duty ratio is increased to D=0.8.

FIG. 26a illustrates the first step leading toward isolation transformer insertion FIG. 26b illustrates the second step of insertion of the magnetizing inductance and FIG. 26c shows the third step of replacing the magnetizing inductance with 1:1 isolation transformer

FIG. 27ab shows another embodiment of present invention with a resonant inductor in series with the transformer primary and no resonant inductors in the current rectifier branches.

FIG. 27b shows the comparison of the magnetic flux density with forward converter and flyback converter.

FIG. 28a illustrates the Integrated magnetics embodiment, FIG. 28b illustrates single magnetic core implementation and FIG. 28c show the elimination of the ripple current from the input inductor.

FIG. 29a illustrates the common AC flux of the input inductor and isolation transformer of the converter in FIG. 28a and FIG. 29b illustrates the flux/per turn as a function of duty ratio D for the converter in FIG. 28a.

FIG. 30a illustrates the current of switch S₁ and FIG. 30b illustrates the current of complementary switch S₂

FIG. 31a illustrates the model for first transition interval and FIG. 31b shows voltage waveforms of switches S₁ and S₂ during the first transition interval, FIG. 31c illustrates the model for second transition interval and FIG. 31d shows voltage waveforms of switches S₁ and S₂ during the second transition interval.

FIG. 32a illustrates the salient waveforms for D=0.33 and operation with zero voltage switching and FIG. 32b illustrates the salient waveforms for D=0.5 and operation with zero voltage switching.

FIG. 33a illustrates another isolated converter embodiment of present invention with half-bridge connection on the output side to reduce ripple current and ripple voltage on output, FIG. 33b shows the three currents for D=0.5 and FIG. 33c illustrates output current i₀.

FIG. 34a illustrates first rectifier current and FIG. 34b illustrates the second rectifier current.

FIG. 35a illustrates converter implementation for a voltage step-up from 18V to 300V and FIG. 35b illustrates the voltage gain curve for this case.

FIG. 36a illustrates another embodiment of present invention in FIG. 35a in which a resonant inductor is placed on the primary side of the transformer and two resonant inductors of FIG. 35a are shorted and FIG. 36b illustrates yet another embodiment of converter in FIG. 35a in which the output rectification is changed to the full bridge configuration.

FIG. 37a illustrates a current bi-directional embodiment of the present invention and FIG. 37b are the corresponding switch states.

FIG. 38a is a schematic of a practical implementation of the converter in FIG. 7a for step-down voltage applications offering wide input voltage range and FIG. 38b is the corresponding DC voltage gain.

FIG. 39a is experimental record of zero voltage switching of the switch S₂ and FIG. 39b is experimental record of zero voltage switching of the switch S₁.

FIG. 40 illustrates the primary transformer current (fourth trace from the top) showing positive current at first switching transition and negative current at second switching transition and negative current at second switching transition.

FIG. 41a shows the noninverting and pulsating input current embodiment of present invention and FIG. 41b shows the inverting and pulsating embodiment of the present invention.

FIG. 42a shows the isolated embodiment of the converter in FIG. 41a and FIG. 42b shows the isolated embodiment of the converter in FIG. 41b.

FIG. 43a shows a nonisolated pulsating input current embodiment with a single resonant inductor Lᵣ. FIG. 43b shows an isolated pulsating input current embodiment with a single resonant inductor on transformer primary.

FIG. 44a shows the half-bridge extension of the converter in FIG. 42a and FIG. 44b shows the full bridge extension of the converter in FIG. 42a.

### PRIOR ART

### Prior-Art Boost Converter

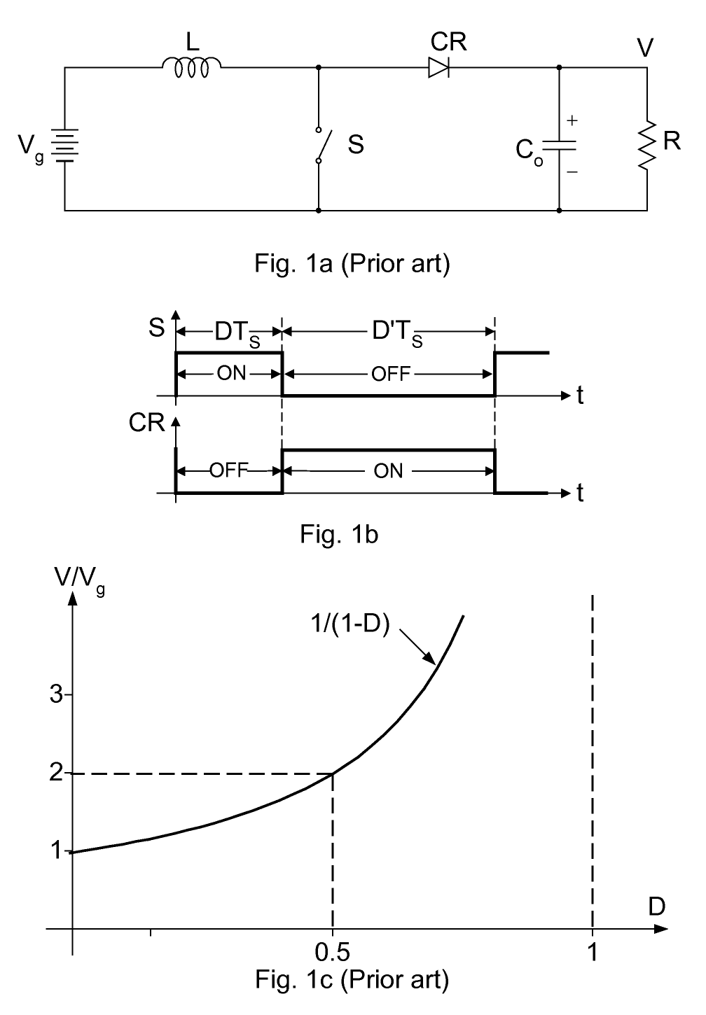

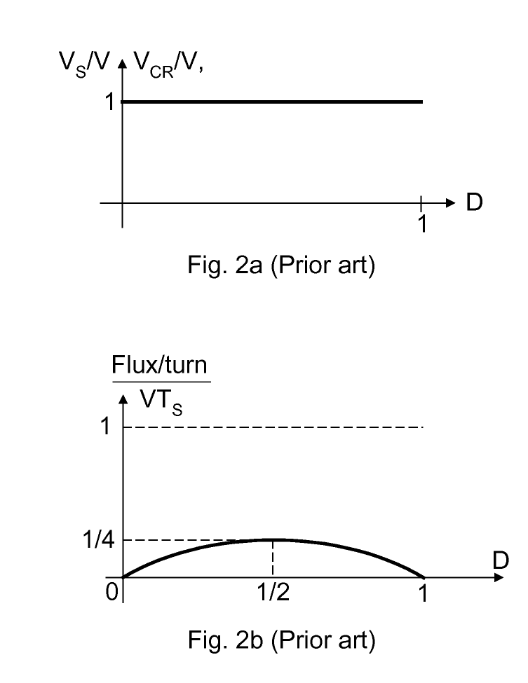

The prior-art PWM boost converter is shown in FIG. 1a, its switching states in FIG. 1b, and DC-voltage gain in FIG. 1c. Note that switches in this boost converter have the voltage stresses equal to output voltage V for any operating duty ratio D as seen in graph of FIG. 2a. The boost converter with its DC gain of 1 or higher, has the output voltage always higher than the input voltage (FIG. 1c). Yet at the start, the output voltage is zero (discharged output capacitor) thus posing a problem in starting this converter. Nevertheless, in this non-isolated version, the start-up problem is circumvented: when input switch opens the diode CR is conducting and the output capacitor is charged with a high in-rush current which must be limited in practice by some in-rush current limiter, such as thermistor.

Another limitation of the prior-art boost converter is that it is a non-inverting configuration, that is, positive input voltage results in positive output voltage. The switching converter with boost DC conversion gain but capable of voltage polarity inversion: positive input voltage resulting in negative output voltage, is apparently missing.

The inductor flux/per turn relative to the output volt seconds (VT_{S}) is illustrated in graph on FIG. 2b as a function of operating duty ratio D. It exhibits a very desirable characteristic that it reaches maximum of 0.25 at duty ratio of 0.5 and is smaller elsewhere per flux characteristic given by:

Flux/turn/VT_{S}=D(1−D) (1)

The objective of the present invention would be to retain such desirable flux characteristic of inductor.

### Prior-Art Isolated Full-Bridge Boost Converter

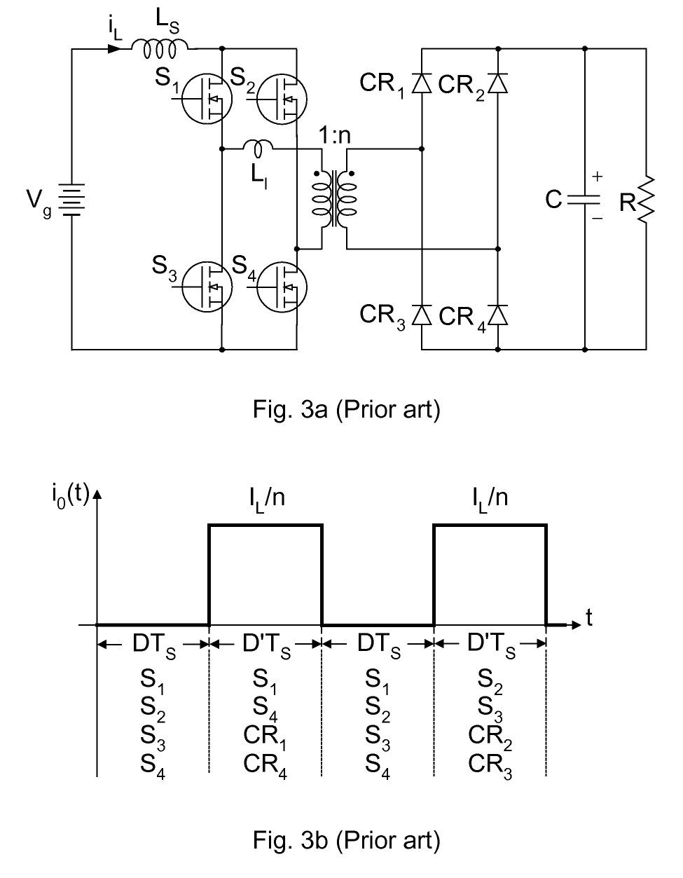

Introduction of the isolation transformer with a step-up turns ratio into a boost converter (FIG. 1a) can further enhance its voltage step-up conversion. Isolation transformer is also desirable and in many applications required for safety reasons. Prior-art isolated Full-Bridge Boost converter is shown in FIG. 3a and its switch-states in FIG. 3b. It consists of the four transistors in a full-bridge configuration on the primary side and four diodes in another full-bridge connection on the secondary side of the isolation transformer, which clearly require complex drive schemes as per FIG. 3b. It has a total of eight switches, which also result in high conduction and switching losses and reduction of overall conversion efficiency as well as increase in size.

Therefore, another objective of the present invention is to provide a converter with much reduced total number of switches. Another severe efficiency limitation is in the energy stored in the leakage inductance of the isolation transformer, which must be dissipated each cycle resulting in losses given by:

Pₗₒₛₛ=½L₁L_{P}²f_{S} (2)

where L₁ is the leakage inductance of the transformer, I_{P} is peak primary current at main switch turn-OFF and f_{S} is the switching frequency. Clearly, the losses are proportional to the switching frequency and in addition to reducing efficiency they prevent reduction of the magnetic size by operating at higher switching frequencies. Furthermore, additional circuitry must be used to dissipate these losses and also limit the peak voltage overshoot on primary side switches.

Therefore, another objective of the present invention is to eliminate the losses due to energy stored in the transformer leakage inductance and instead have this energy recover to the converter in a non-dissipative ways providing also spike-free operation of the primary side switches.

Isolation transformer turns ratio n also provides additional DC conversion gain such that overall DC conversion is:

V=nV_{g}/(1−D) (3)

### Prior-Art Isolated Push-Pull Boost Converter

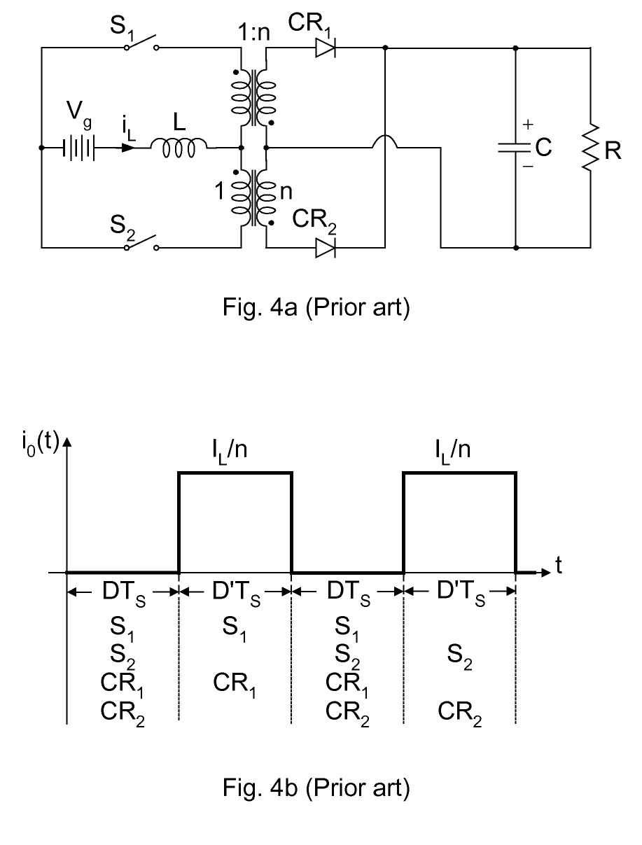

Another prior-art converter is shown in FIG. 4a in which the full-bridge front-end is modified into a push-pull configuration on primary side and center-tapped rectification on secondary side resulting in totals of four switches. However, all the switches now have much increased voltage stresses, such as two, three times higher than their respective input DC voltage and output DC voltages. In addition, the transformer with the center-tap primary as well as center-tap secondary has a poor winding utilization and efficiency limitations at high switching frequencies.

### Prior-Art SingleEnded Boost Converter

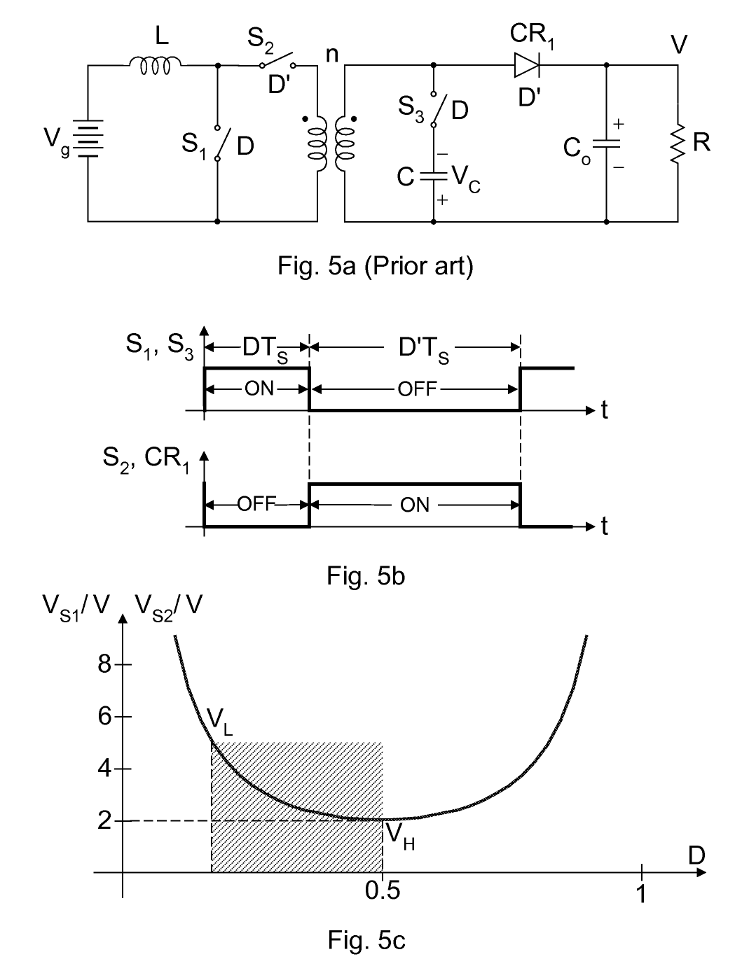

This prior-art converter is shown in FIG. 5a, its switch states in FIG. 5b and voltage stresses in FIG. 5c. The excessive voltage stresses make this configuration practically unusable.

### Prior-Art Two-Stage Solutions

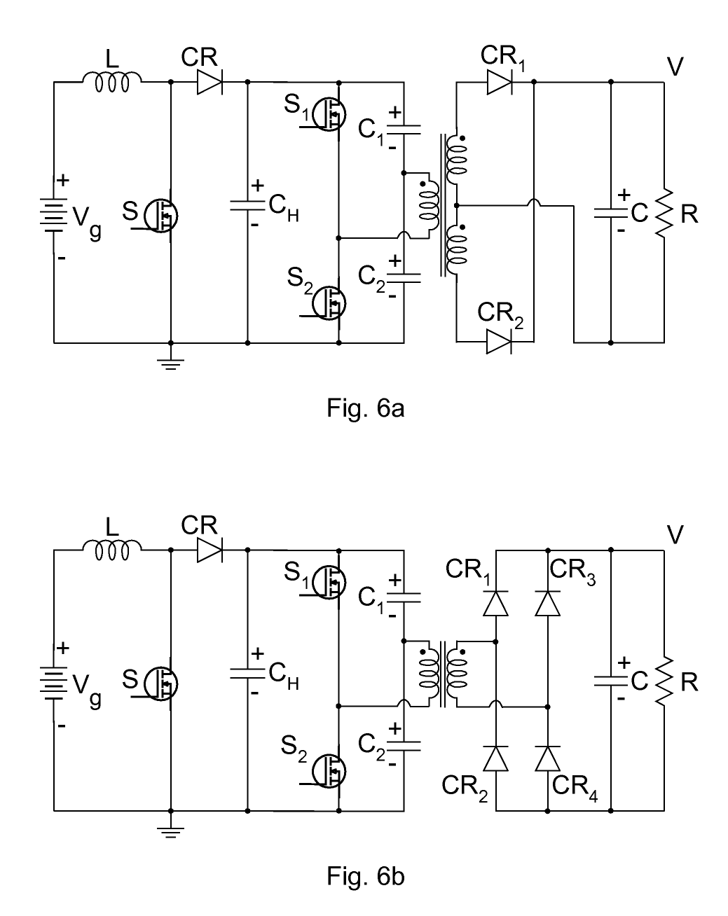

In some applications the two-stage solution is practiced as shown in FIG. 6a and FIG. 6b. The front-end boost converter provides the DC voltage step-up, while the second stage provides the isolation with the fixed voltage conversion gain due to half-bridge primary side connection operated at fixed 50% duty ratio.

In addition to large number of switches, the two-stage solution limits the efficiency, as the power must be processed through two distinct power conversion stages.

Therefore, another objective of the present invention is to provide a converter, which provides both regulation and isolation in the single-stage power processing solution, hence resulting in higher efficiency.

### Objectives

The objectives of the present invention are therefore to eliminate all of the above shortcomings of the prior-art converters and find isolated switching converters with the basic boost voltage step-up gain with following desirable properties:
a) The small number of switches and their simple drive and control
b) The low voltage stresses on all switches
c) No losses due to leakage inductance of the isolation transformer
d) Zero voltage switching of the primary side switching devices
e) Wide input voltage range of 4:1 or more.

### SUMMARY OF THE INVENTION

### Basic Operation

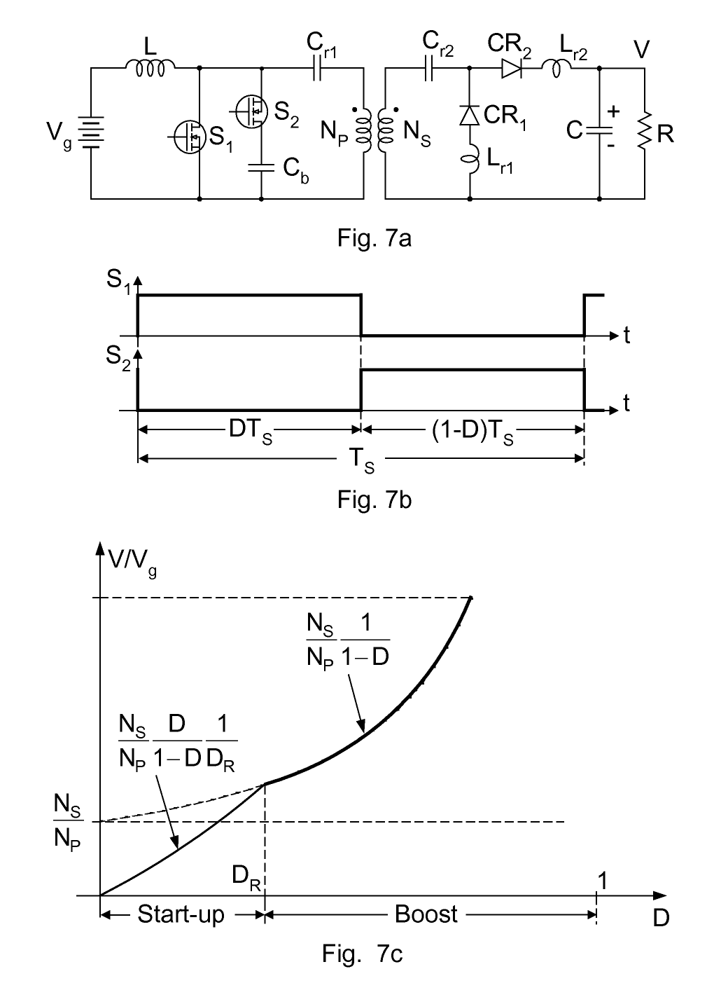

One embodiment of the present invention is shown in FIG. 7a. The converter consists of the two primary side controlling switches S₁ and S₂ with their respective switch states in FIG. 7b and two current rectifier switches CR₁ and CR₂ on the transformer secondary side resulting in two distinct switching networks: one for the ON-time interval and another for the OFF-time interval.

It also has PWM magnetic components, the input inductor and the isolation transformer, which are flux balanced over the entire switching cycle. The two resonant inductors Lᵣ₁ and Lᵣ₂ are placed in respective current rectifier branches as shown in FIG. 7a and are fully flux-balanced over their respective ON-time interval only (Lᵣ₁) or OFF-time interval only (Lᵣ₂). The converter operation is based on the hybrid-switching method, which will be explained and analyzed in more details in later resonant analysis sections.

The converter also has the primary side resonant capacitor Cᵣ₁ and secondary side resonant capacitor Cᵣ₂, which form with the resonant inductor Lᵣ₁ one resonant circuit for ON-time interval and with resonant inductor Lᵣ₂ another independent resonant circuit during the OFF-time interval. Despite the presence of two half-wave resonant currents, one during the ON-time interval and another during the OFF-time interval, the converter output DC voltage is controlled by a duty ratio D of the primary switches resulting in the DC voltage gain displayed in FIG. 7c consisting of the step-down/step-up region and the step-up region.

### Non-Isolated And Non-Inverting Topology

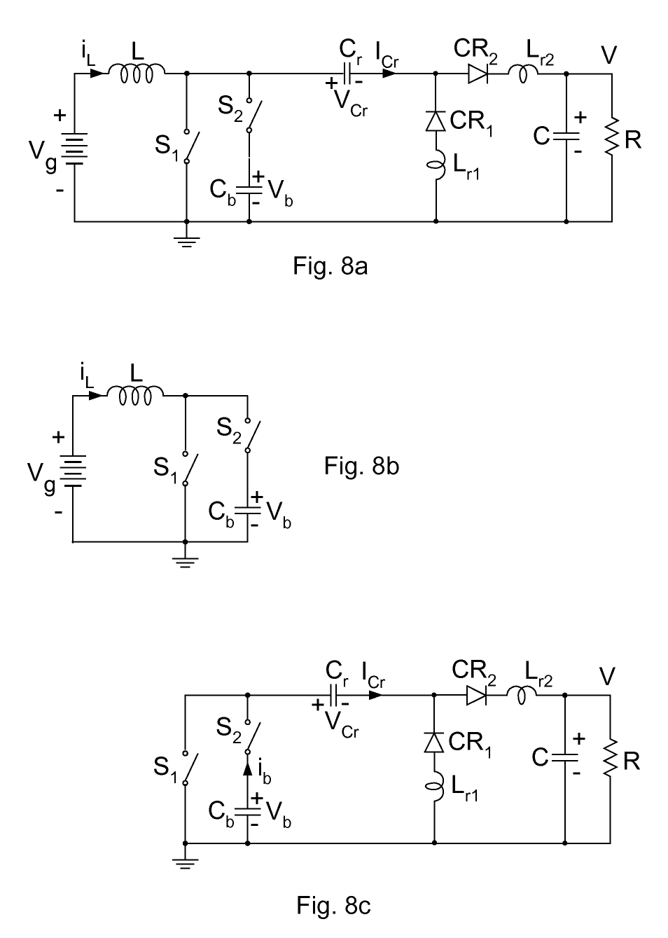

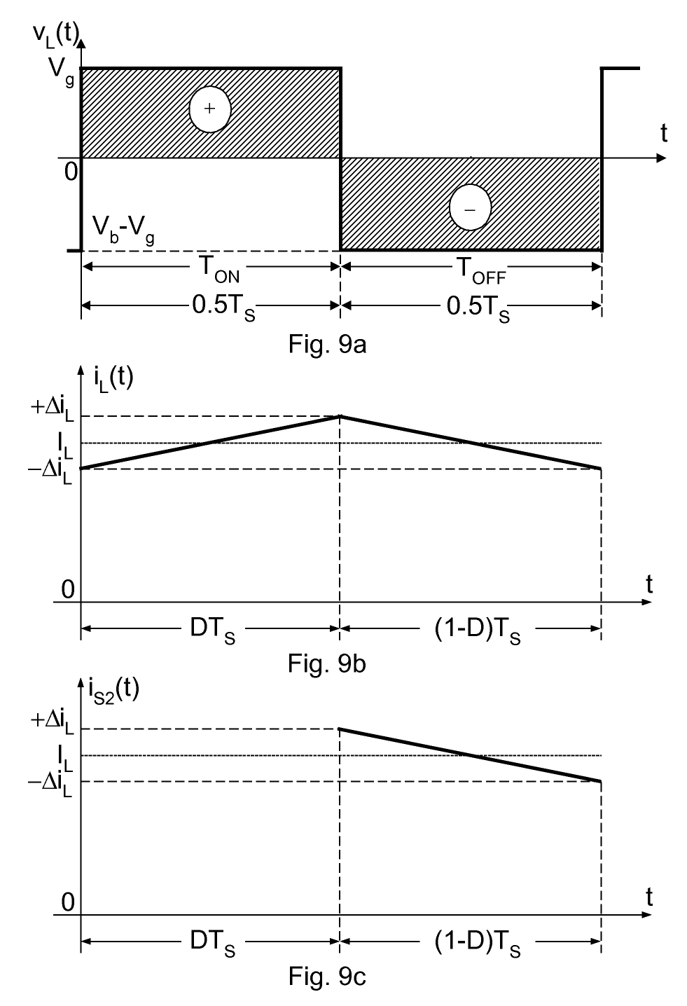

The non-isolated and non-inverting embodiment of the present invention is shown in FIG. 8a obtained by simply shorting the isolation transformer in FIG. 7a. In that case, the two series resonant capacitors are combined into a single resonant capacitor Cᵣ shown in FIG. 8a.

The explanation of the converter operation is now facilitated by decomposing the original converter of FIG. 8a into two separate converters shown in FIG. 8b and FIG. 8c respectively. Note that the two switches S₁ and S₂ are common and present in both converters. Thus, the waveforms of the original converter in FIG. 8a will be obtained by superposition of the waveforms in the two separately analyzed converters.

The converter in FIG. 8b operates as a boost converter, so that the DC voltage gain V_{b}/V_{g} can be found as:

V_{b}/V_{g}=1/(1−D) (4)

The converter in FIG. 8c has the unity DC voltage gain since it operates with two half-wave resonances so that:

V/V_{b}=1 (5)

resulting in an overall step-up voltage gain V/V_{g} given by:

V/V_{g}=1/(1−D) (6)

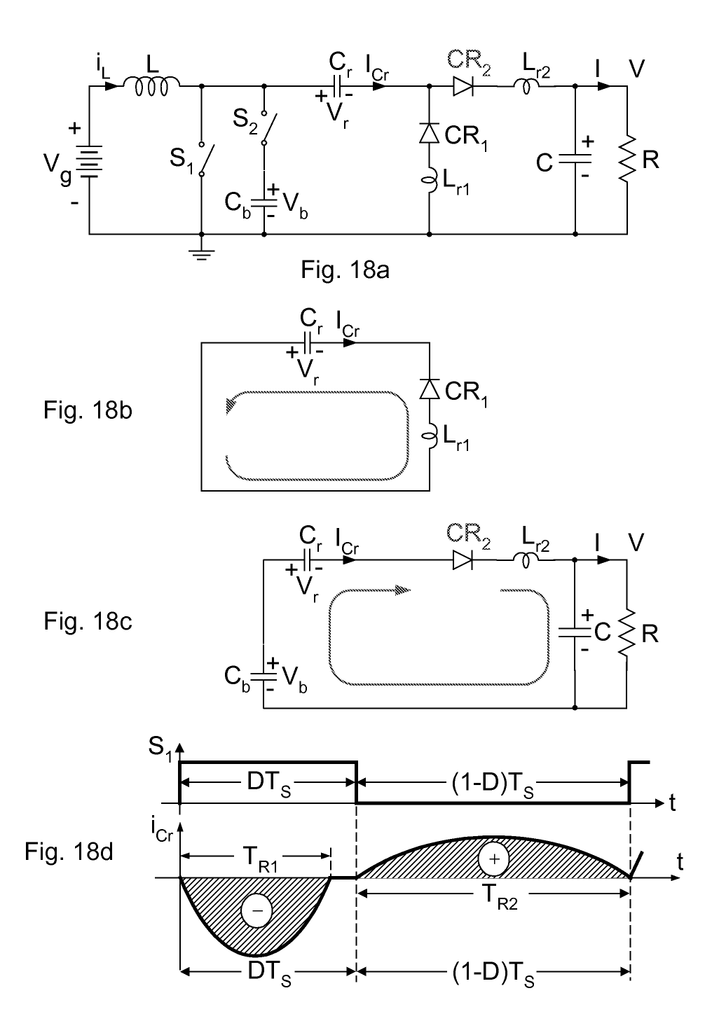

In the subsequent analysis, the predicted and experimental waveforms are illustrated first for the special case when the two resonant inductors are equal (Lᵣ₁=Lᵣ₂) thus resulting in equal resonant conduction intervals and resonant capacitor current with equal positive current (charge) and equal negative current (discharge). The most general case of different resonant inductor values and different resonant conduction periods is displayed later in FIG. 18c.

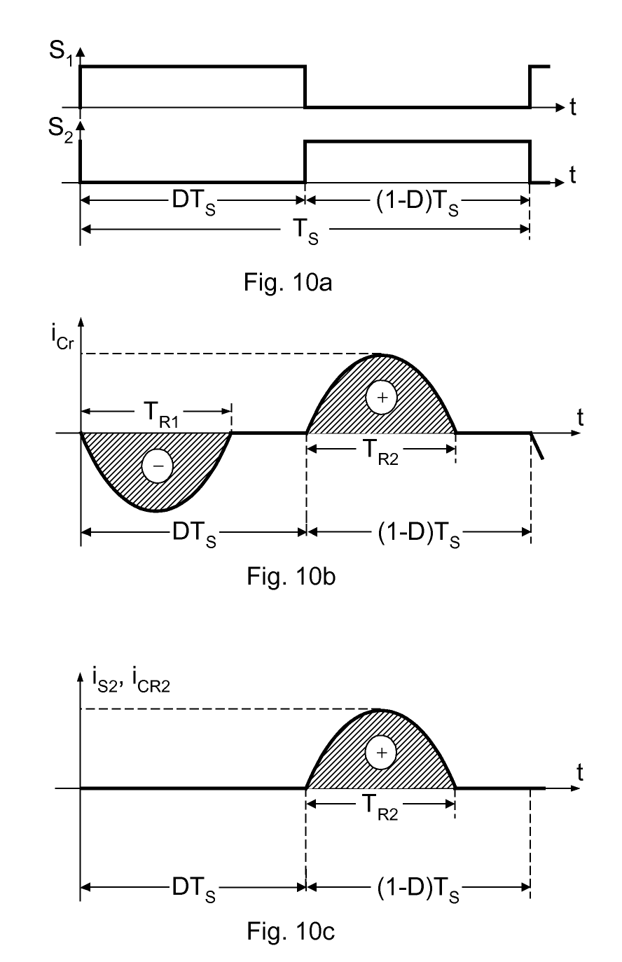

The salient waveforms of the converter in FIG. 8b are: input inductor L voltage (FIG. 9a), input inductor current (FIG. 9b) and switch current S₂ (FIG. 9c). The salient waveforms of the converter in FIG. 8c for D=0.5 are: switch states (FIG. 10a), the resonant capacitor current i_{Cr} (FIG. 10b) and the currents in switch S₂ and rectifier CR₂ (FIG. 10c). As the resonant capacitor charge and discharge must be equal in steady state (area under the respective resonant current waveforms in FIG. 10b) the respective input and output current to the converter of FIG. 8c are equal resulting in unity DC current gain and therefore unity DC voltage gain at all operating duty ratios.

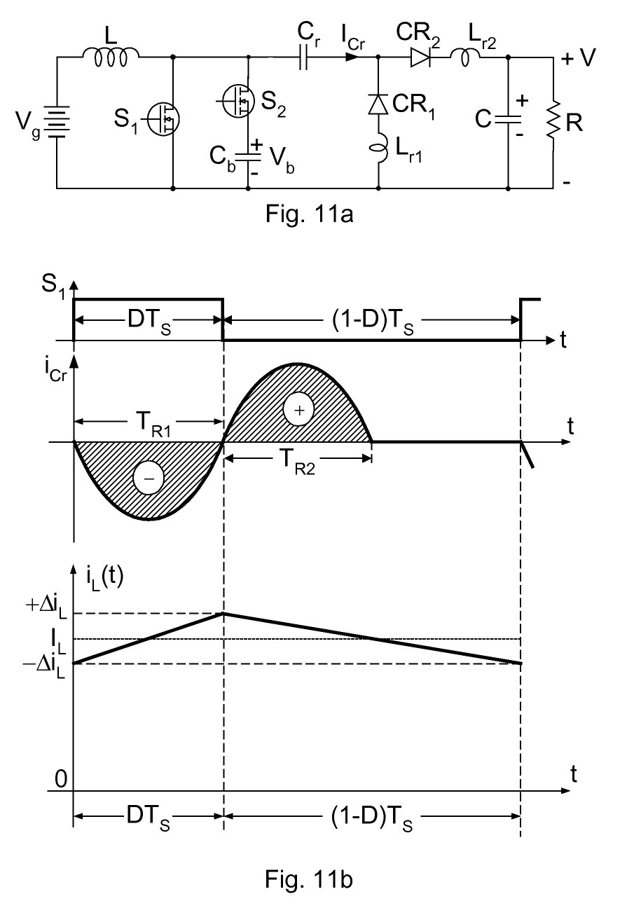

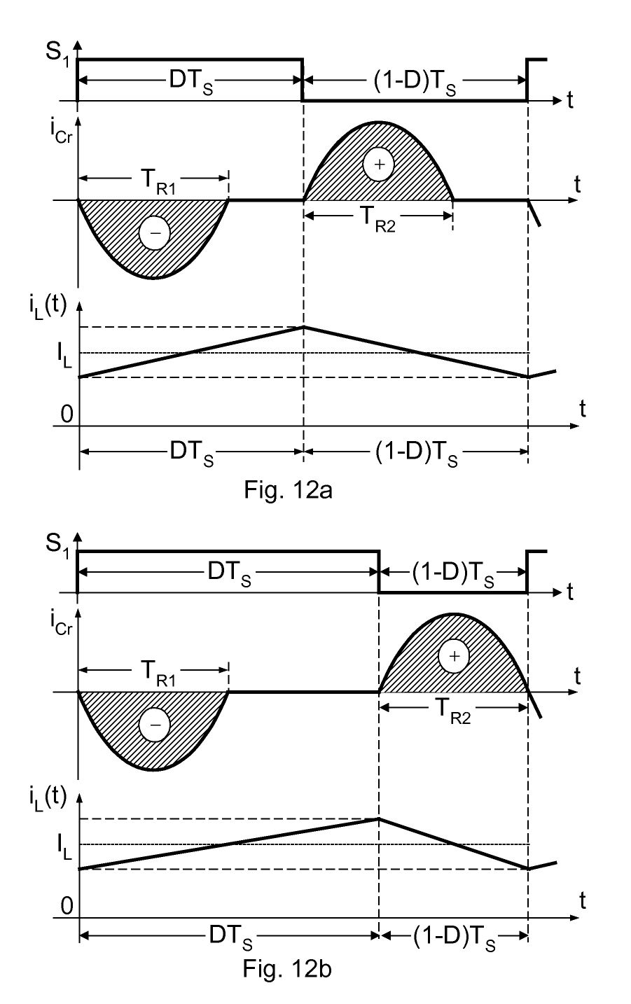

Shown in FIG. 11a is the implementation of the switches S₁ and S₂ with MOSFET transistors. Note how the change of duty ratio from D=0.5 to D=0.33 results in the second half-resonant current continuing immediately after the first half-resonant current as seen in FIG. 11b (middle waveform), while the input inductor current has the waveform shown in FIG. 11 (bottom waveform). FIG. 12a shows the same waveforms for D=0.5 and FIG. 12b for D=0.66.

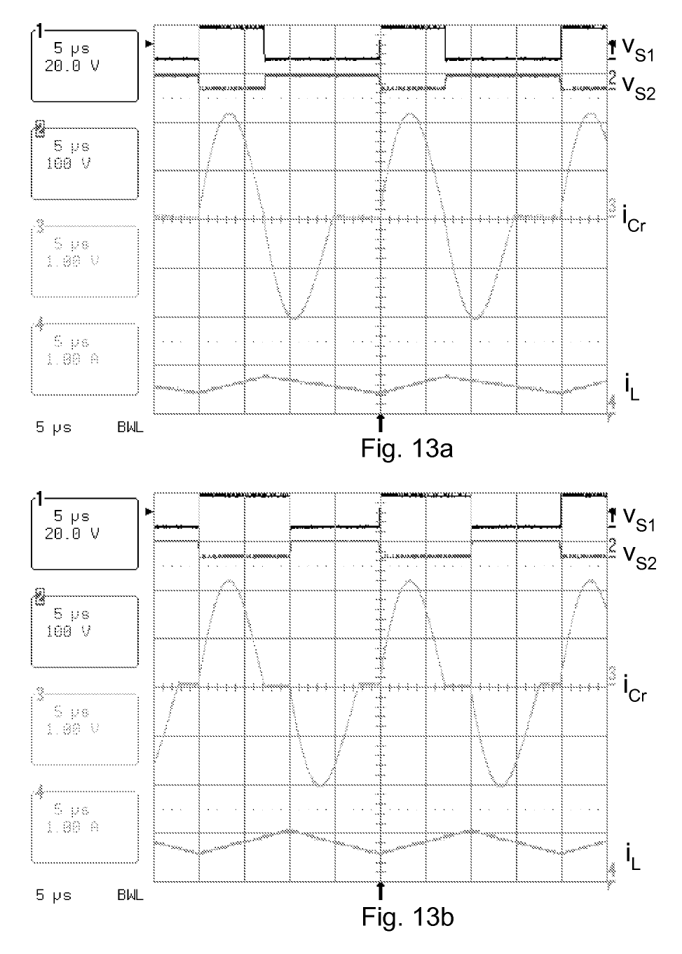

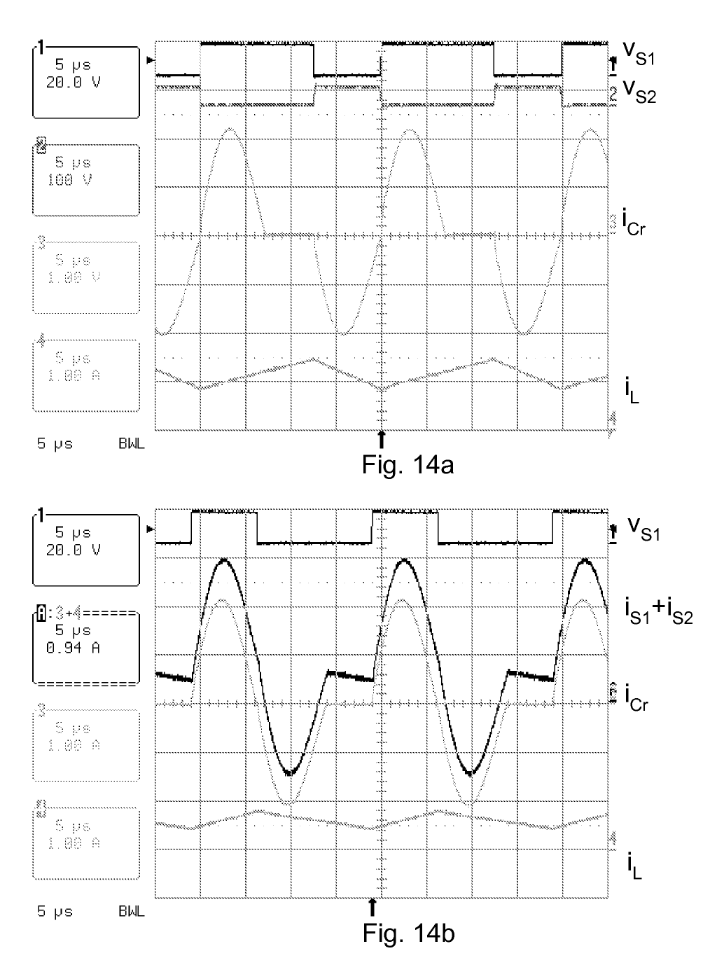

The experimental prototype was built to first verify the resonant current waveforms and input inductor current waveforms for the three duty ratios D=0.33, D=0.5 and D=0.66 which are illustrated in FIG. 13a, FIG. 13b and FIG. 14a respectively.

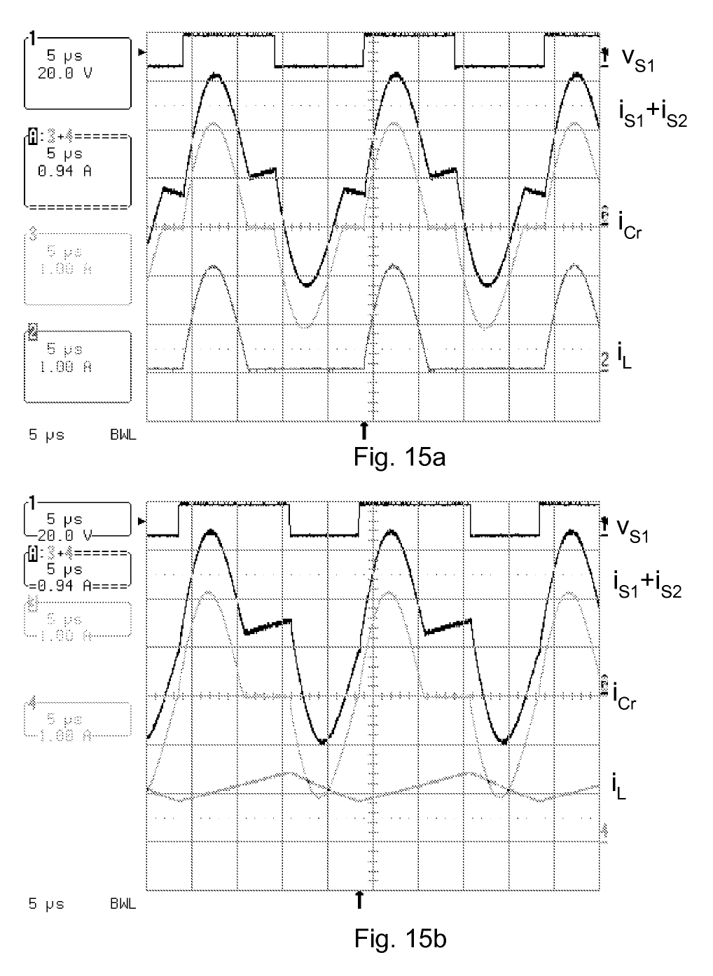

The composite switch current (i_{S1}+i_{S2}) consisting of the sum of switch currents S₁ and S₂ is shown for the same duty ratios in FIG. 14b, FIG. 15a and FIG. 15b respectively. Note how composite switch current has also a corresponding input inductor current component. The switch current S₁ is equal to the composite current during the ON-time interval. The switch S₂ current is equal to the composite current during the OFF-time interval and is clearly an AC current, as the average of that current during OFF-time interval is zero. This is consequence of the fact that the total current through S₂ switch must be completely charged balanced during the OFF-time interval alone.

### Detailed Analysis of the Non-Isolated Step-Up Converter

We will break down the analysis of the converter into superposition of the PWM boost converter and a separate non-isolated DC-to-DC converter with unity voltage gain in which S₁ and S₂ switches have a dual role.

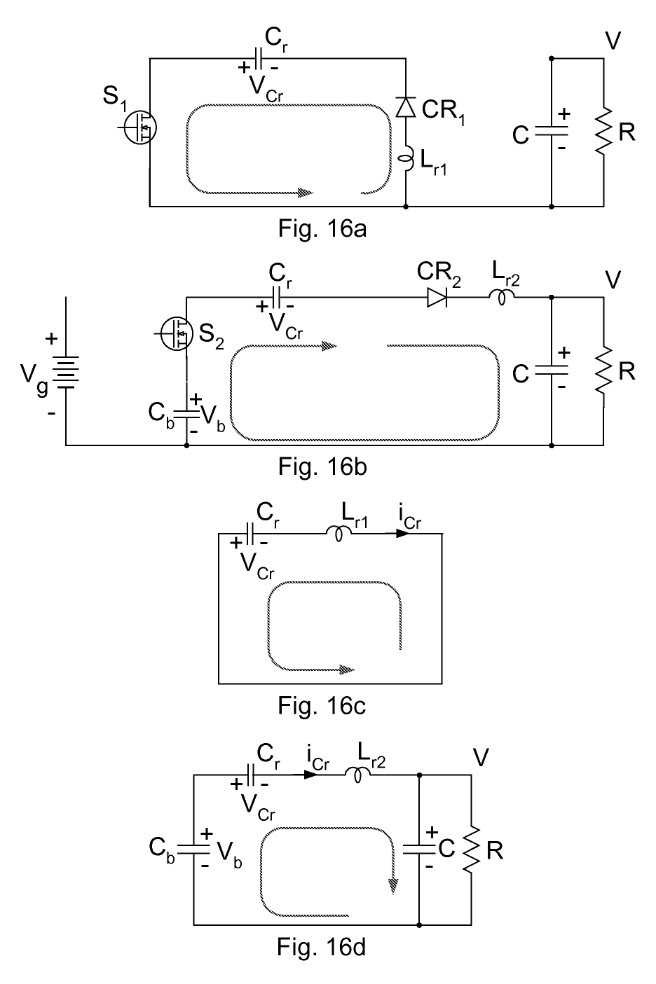

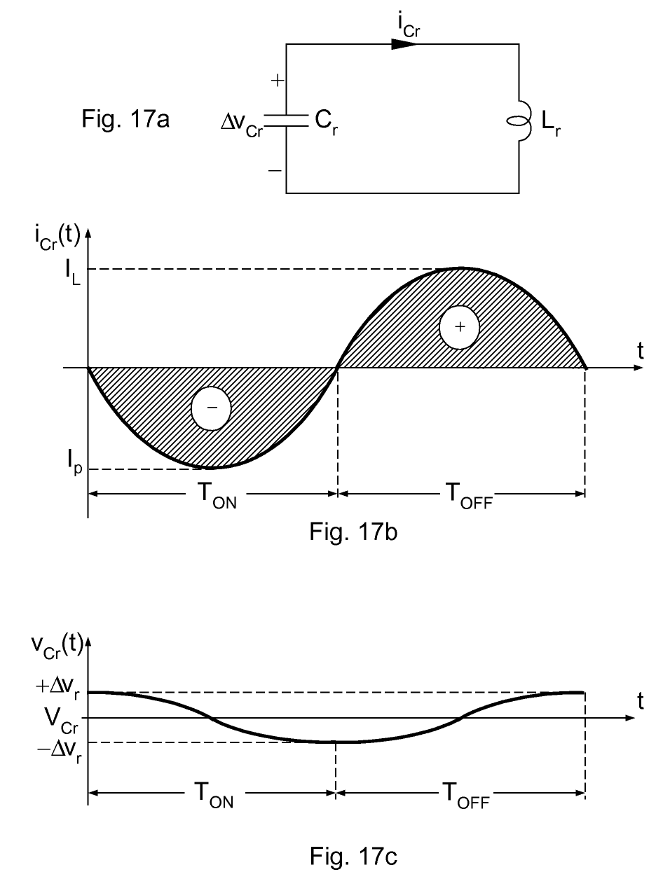

Applying volt-second criteria on inductor voltage waveform of FIG. 9a the DC voltage gain of (4) is obtained. Note that the DC voltage V_{b} on capacitor C_{b} is now an effective input DC voltage source to the unity DC voltage gain converter with two switched networks shown in FIG. 16a for ON-time interval and FIG. 16b for OFF-time interval. Note that the MOSFET switches in series with respective diode rectifiers are left in the circuit models to designate that for each resonant circuit, only one (positive) half of sinusoidal resonant current will actually flow due to presence of respective current rectifiers.

Each of the two switched networks can then be simplified into the respective resonant circuit models of FIG. 16c and FIG. 16d for ON-time and OFF-time intervals. Since the first resonant inductor current must be fully volt-second balanced during the ON-time interval respectively (can not support net DC voltage), the resonant model of FIG. 16c requires that:

V_{Cr}=0 (7)

However, the summation of DC voltages in the second resonant circuit for the OFF-time interval (FIG. 16d) imposes another condition:

V_{b}−V_{Cr}=V (8)

Replacing (7) in (8) we obtain:

V_{b}=V (9)

which confirms the earlier predicted result (6) on the basis of the 1:1 DC voltage gain of the second converter. After the above DC relationships are used, the two equivalent circuit models of FIG. 16c and FIG. 16d result in an identical AC resonant circuit model of FIG. 17a void of any DC voltages. The resonant current waveform and resonant capacitor voltage waveform are shown in FIG. 17b and FIG. 17c respectively for the special case when:

T_{R1}=T_{R2}=0.5T_{S} (10)

The general case, when the first resonant interval Tᵣ₁ and second resonant interval Tᵣ₂ are different is analyzed in next section subject to the operating conditions given by:

T_{R1}∠DT_{S} (11)

T_{R2}∠(1−D)T_{S} (12)

For the following analysis of the two resonant circuits, we will assume that the output capacitor C and the boost capacitor C_{b} have much larger value (several times) that the resonant capacitor Cᵣ, so that the two resonances are solely determined by the resonant capacitor Cᵣ and the two resonant inductors Lᵣ₁ and Lᵣ₂.

### Analysis of First Resonant Circuit

Cᵣdv_{Cr}dt=−iᵣ₁ (13)

Lᵣ₁diᵣ₁/dt=v_{Cr} (14)

Resonant circuit equations (13) and (14) subject to the initial conditions imposed during the previous OFF-time interval given by:

iᵣ₁(0)=0 (15)

v_{Cr}(0)=Δvᵣ (16)

The resonant solution is obtained as:

iᵣ₁(t)=I_{P} sin(ωᵣ₁t) (17)

v_{Cr}(t)=Δvᵣ cos(ωᵣ₁t) (18)

Δvᵣ=I_{P1}R_{N1} (19)

R_{N1}=√Lᵣ₁/Cᵣ (20)

where R_{N1} is the natural resistance and

ωᵣ₁1/√Lᵣ₁Cᵣ (21)

fᵣ₁=ωᵣ₁/(2π) (22)

tᵣ₁=1/fᵣ₁=2T_{R1} (23)

where fᵣ₁ is the first resonant frequency and ωᵣ₁ is first radial frequency and T_{R1} is the first resonant conduction period equal to one half of the first resonant period tᵣ₁.

### Analysis of Second Resonant Circuit

Cᵣdv_{Cr}dt=−iᵣ₂ (24)

Lᵣ₂diᵣ₂/dt=v_{Cr} (25)

Resonant circuit equations (9) and (10) are subject to the initial conditions imposed during the previous OFF-time interval given by:

iᵣ₂(0)=0 (26)

v_{Cr}(0)=Δvᵣ (27)

The resonant solution is obtained as:

iᵣ₂(t)=I_{P2} sin(ωᵣ₂t) (28)

v_{Cr}(t)=Δvᵣ cos(ωᵣ₂t) (29)

Δvᵣ=I_{P2}R_{N2} (30)

R_{N2}=√Lᵣ₂/Cᵣ (31)

Where R_{N2} is the natural resistance and

ωᵣ₂=/√Lᵣ₂Cᵣ (32)

fᵣ₂=ωᵣ₂/(2π) (33)

tᵣ₂=1/fᵣ₂=2T_{R2} (34)

where fᵣ₂ is the second resonant frequency and ω_{r 2} is second radial frequency and T_{R2} is the second resonant conduction period equal to one half of the second resonant period tᵣ₂.

### Best Mode of Operation

The best mode of operation is to satisfy the relationships given by (11) and (12), so that each of the half sinusoidal resonances are completed within their corresponding ON-time and OFF-time intervals resulting in some zero current coasting intervals and constant switching frequency.

The equivalent circuit models in FIG. 18a and FIG. 18b are for general case when two resonant conduction periods are different for the converter of FIG. 8a. The corresponding general resonant capacitor current is illustrated in FIG. 18c. Note how the second resonant conduction period is now effected by both the choice of capacitor C_{b} and the resonant inductor Lᵣ₂ since the output capacitor C is much larger than both Cᵣ and C_{b}.

### Polarity Inverting Embodiment

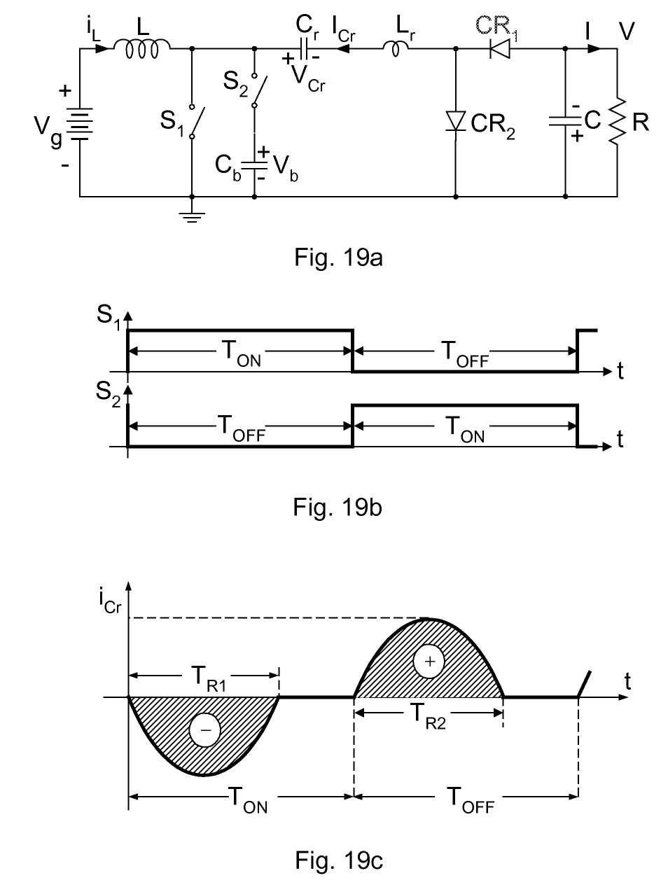

Polarity inverting extension is shown in FIG. 19a, the switch states in FIG. 19b and the corresponding resonant capacitor current in FIG. 19c. The converter in FIG. 19a shows another embodiment of the present invention in which the two resonant inductors in rectifier branches are shorted and a single resonant inductor Lᵣ is introduced in the branch with the resonant capacitor Cᵣ as shown in FIG. 19a.

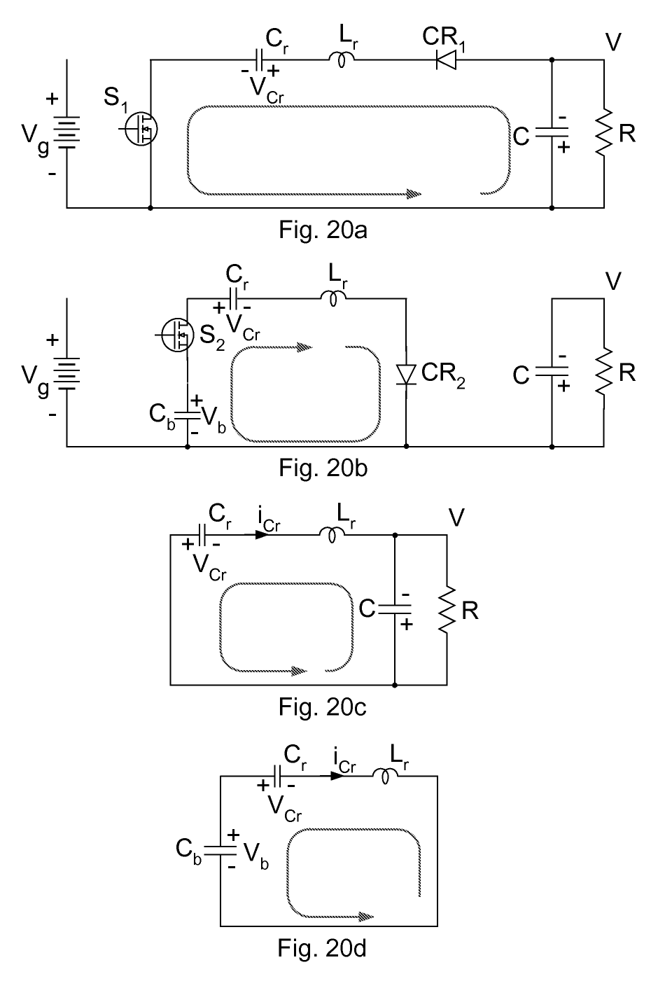

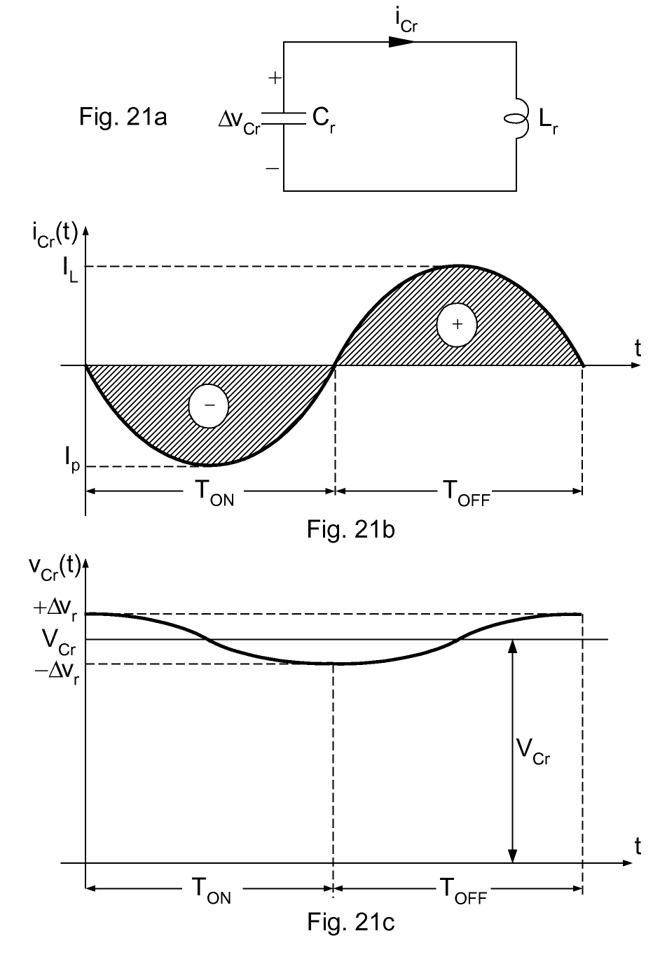

The corresponding equivalent circuit models are illustrated in FIG. 20a-20d. Note that when output capacitor C is much larger than resonant capacitor Cᵣ the first resonant equivalent circuit model of FIG. 20c reduces to the one in FIG. 21a. Likewise, when the boost capacitor C_{b} is much larger than the resonant capacitor Cᵣ the second resonant circuit model of FIG. 20d also reduces to the same resonant circuit model of FIG. 21a.

The special case when the two resonant intervals are equal to half the switching period result in resonant capacitor current as shown in FIG. 21b and resonant capacitor voltage as in FIG. 21c.

### Voltage Stresses of Switches

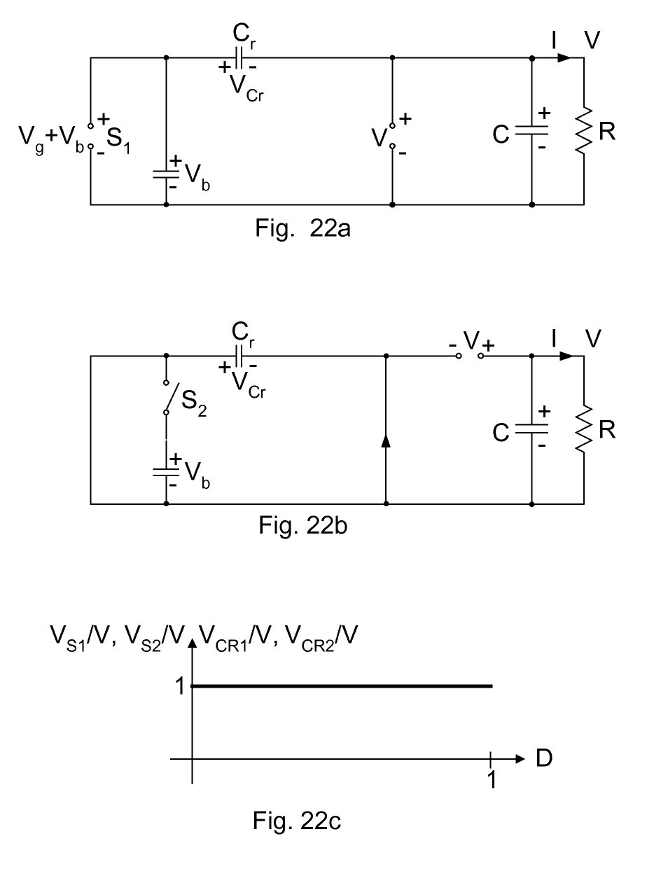

Model for ON-time interval displaying switch voltage stresses is in FIG. 22a while the model for OFF-time interval displaying corresponding switch voltage stresses is shown in FIG. 22b. Since V_{b}=V, the voltage stresses of all switches are equal to output DC voltage V and independent from the operating duty ratio D as illustrated in FIG. 22c and are:

V_{S1}/V=V_{S2}/V=V_{CR1}/V=V_{CR2}/V=1 (35)

Therefore, the first objective of the present invention is met.

### Soft Start

Another drawback of the present isolated boost converters is that they need additional circuits to enable converter to start-up. The present invention on the other hand eliminates that problem entirely. When the duty ratio D is reduced below the resonant duty ratio D_{R} defined by:

D_{R}=T_{R1}/Ts (36)

the converter changes to a step-up/step-down DC voltage gain given by:

V/V_{g}=D/(1−D)D_{R} (37)

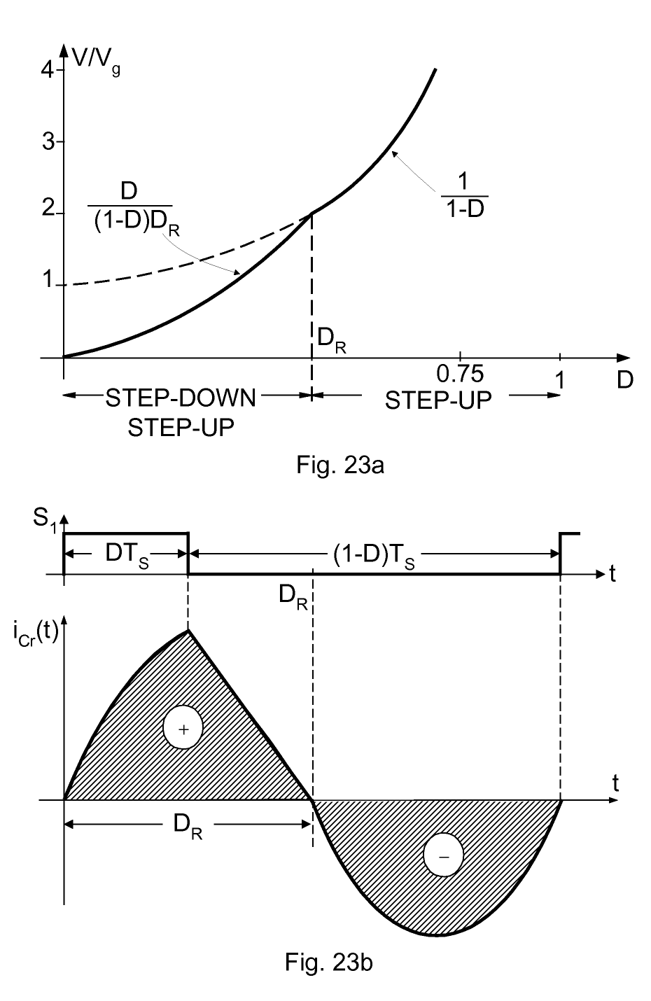

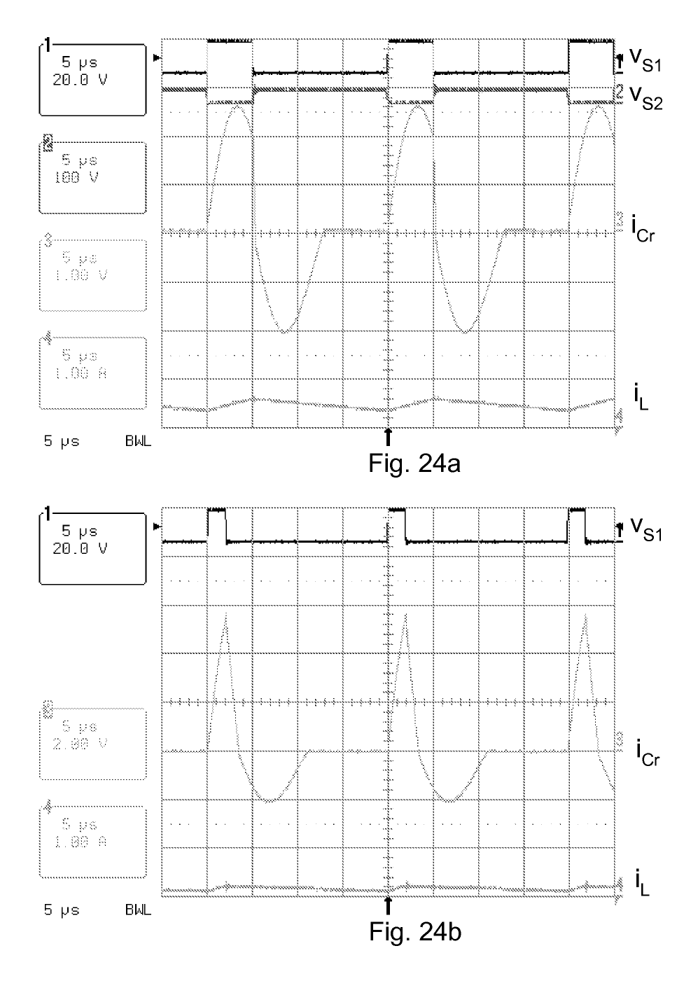

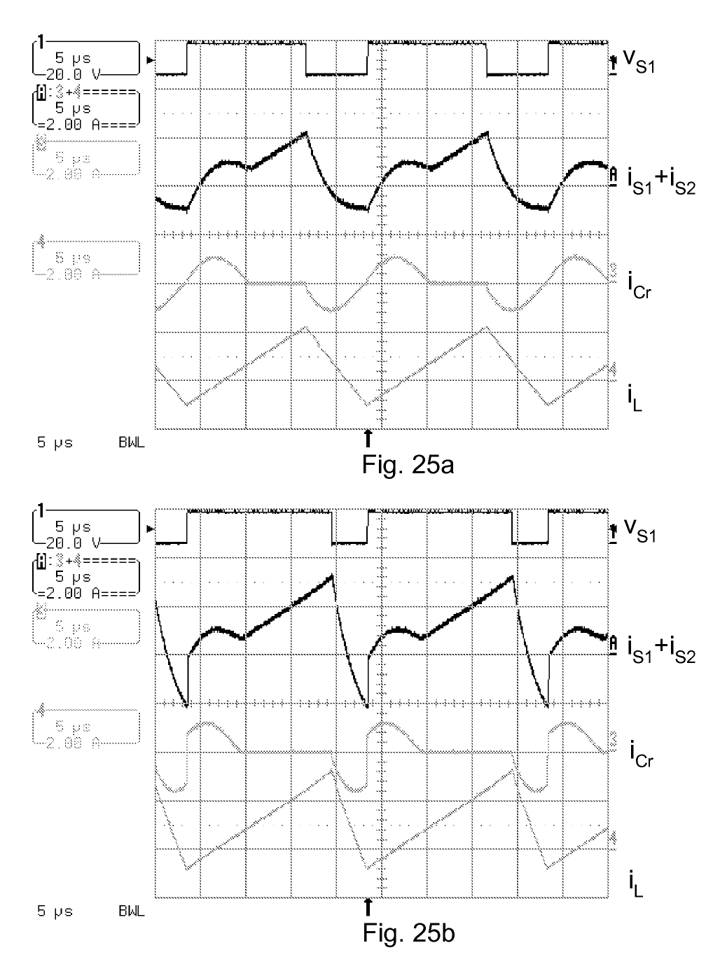

and shown by the DC voltage gain in FIG. 23a. Note that when D=D_{R} there is a smooth changeover to the boost voltage gain given by (4). The duty ratio D_{R} is a boundary at which the change over takes place. Note that when actual duty ratio is smaller than D_{R}, capacitor resonant current changes to the one shown in FIG. 23b. The experimental waveform of the resonant currents in FIG. 24a and FIG. 24b show the increased peak resonant current followed by the linear inductor current decrease. Thus the converter has a smooth start up from zero DC voltage and at duty ratio D_{R} changes to a step-up conversion gain (4).

It was already shown earlier in FIG. 11b, FIG. 12a and FIG. 12b and corresponding experimental waveforms how the duty ratio change from D=0.33 through D=0.5 to D=0.66 increases the input voltage per DC voltage gain given by (4) while half-wave resonant currents are preserved. However, as shown in graph of FIG. 23a voltage step-up continues further with the increase of duty ratio D higher than 0.66. This is confirmed with another experimental prototype which once again shows that at D=0.66 the boundary point is reached when the second resonance is still half-sine wave as seen on the third trace from the top in FIG. 25a which shows the waveform of the resonant capacitor current. However, further increase of duty ratio to D=0.8 will result in further significant increase of the output voltage as per graph in FIG. 23a. However, note that both the first and the second resonant currents are no longer half-sinusoidal, but are instead distorted into a waveform shown in third trace from the top in FIG. 25b. Note, however, that the areas under the two current waveforms must be equal, as it is required to satisfy equal charge and discharge of the resonant capacitor Cᵣ during each period. Clearly the higher the duty ratio, the bigger will be the peaks of these waveform and less efficient the operation of the converter. Therefore, this cutting in should be avoided to preserve the higher efficiency at high duty ratios by properly choosing optimally the two resonant inductors.

Similarly for duty ratios D lower than resonant duty ratio D_{R} another distortion of the resonant currents into high peak values takes place. Hence this region should also be avoided when the high efficiency is needed and used only for start-up operation.

Nevertheless it is established both theoretically and confirmed experimentally, that despite the two clearly defined resonant conduction periods, T_{R1} and T_{R2}, the control of the output DC voltage is obtained solely by the duty ratio D control at constant switching frequency just as the prior-art Isolated Full-Bridge Boost converter, but with much smaller number of switches (3) compared to eight in Full-Bridge Boost converter. This is owing to the new Hybrid-switching method, which is reviewed next.

### Hybrid Switching Method

In this method, there are two types of the magnetic components:
1. PWM magnetic components such as input inductor and the isolation transformer in the present invention, which are fluxed balanced over the entire switching period.
2. Resonant inductors, which are fully flux balanced during one subinterval, such as

ON-time interval or OFF-time interval. In the present invention, there are two such resonant inductors, where first resonant inductor is fully flux balance during ON-time interval only and second resonant inductor, which is fully flux-balanced during the OFF-time interval. Their separation and independence is actually insured by placing them in series with each rectifier branch, thus insuring their conduction in respective ON-time interval and OFF-time interval.

Note that the above placement of the resonant inductors is fundamentally different from conventional resonant and multi-resonant converters, in which resonant inductors are placed so that their resonant interval is not restricted to either ON-time or OFF-time intervals, but are actually permitted to resonate during the whole switching period like the regular PWM inductors. The net consequence of that is that they operate most of the time in conflict with the regular PWM inductors, causing distortion of the voltage and current waveforms and increase of the voltage and/or current stresses on both switches.

The ultimate drawback of conventional resonant methods is that the output voltage can not be controlled by duty ratio only but by resonant control methods. In the present invention based on Hybrid-switching method, despite the presence of the two resonances, the output voltage is controlled solely by the duty ratio D control of the main switch and can fully be regulated from no load to full load, which is not the case with the resonant control methods, which fail to do so at light load and no load conditions.

Hence Hybrid-switching method is a unique combination of the square-wave (PWM) switching and resonant switching which preserves the control and regulation properties of PWM converters but provide additional advantages, such as reduced number of switches, the reduction of their voltage stresses and better utilization of the magnetic components.

### Insertion of the Isolation Transformer

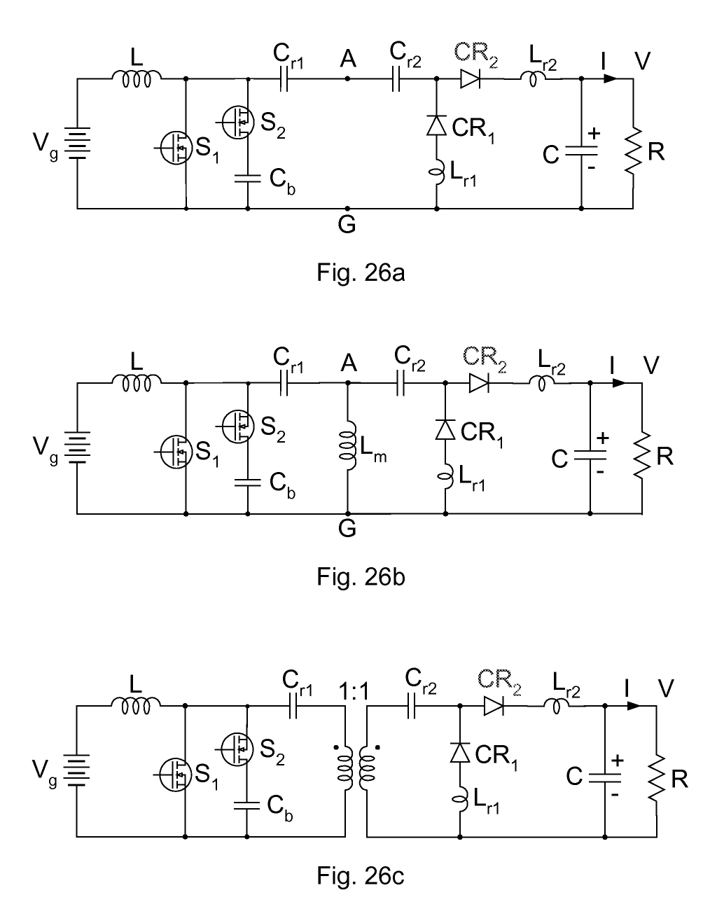

The insertion of the isolation into the prior art boost converter of FIG. 1a required the use of 8 switches to convert it into a prior-art Isolated Full Bridge Boost converter of FIG. 3a. One of the advantages of the present invention is that the non-isolated converter embodiment of FIG. 8a can be transformed into an isolated version with no addition of the switches by using the following sequence of steps:
1. Break the single resonant capacitor into two resonant capacitors Cᵣ₁ and Cᵣ₂ connected in series such as shown in FIG. 26a with a connecting point marked A.
2. Insert an inductor between the points A and G such as shown in FIG. 26b. Clearly this inductor is an AC inductor with no DC bias. As both resonant capacitors must be charge balanced, there is no net DC current coming into this inductor form either side.
3. Separate this AC inductance into a two winding 1:1 turns ratio isolation transformer such as shown in FIG. 26c.

Note that the same number of switches and the operation of the converter is preserved as in original non-isolated version, but with additional benefits discussed in sections below.

### Another Embodiment With Isolation Transformer

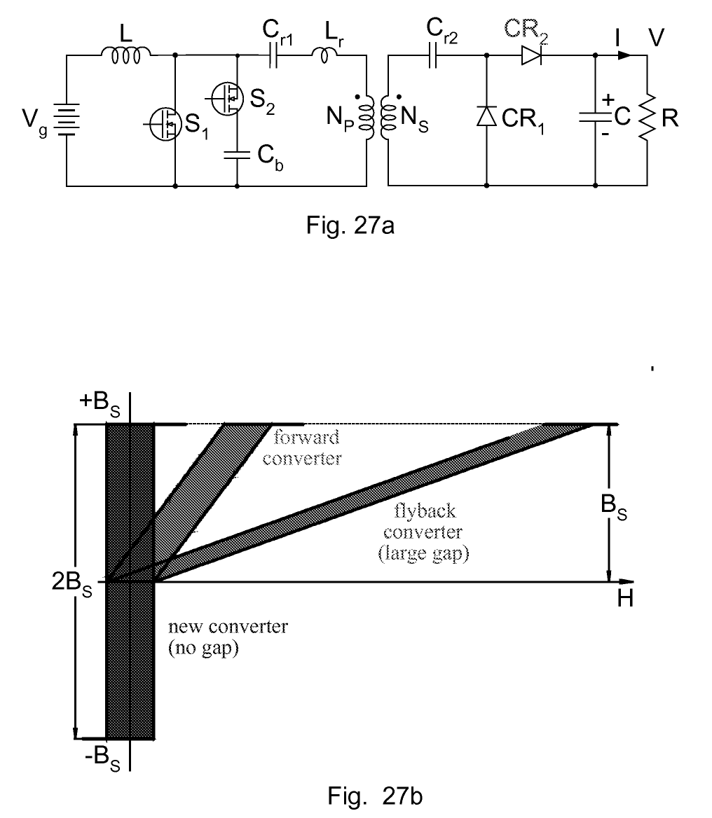

Shown in FIG. 27a is another embodiment of the present invention of FIG. 7a. In this embodiment, the two resonant inductors in the current rectifier branches are shorted and a resonant inductor is introduced on the primary side of the isolation transformer and in series with the resonant capacitor Cᵣ₁ on the primary side. The two resonant intervals cannot any more be independently controlled and result in the same resonant interval when boost capacitor is much larger then the equivalent resonant capacitor Cᵣ formed by series connection of two resonant capacitors. However, the boost capacitor C_{b} can still be used to provide two different resonant intervals once its value is comparable or smaller than resonant capacitor Cᵣ.

In some cases, even the resonant inductor Lᵣ on the primary side can be shorted and eliminated, and the leakage inductance of the isolation transformer used to provide the proper resonant intervals. Clearly in that case, this adjustment can be made by use of the actual measured value of the leakage inductance and using the resonant solution given earlier determine the proper size of the resonant capacitor Cᵣ₁ to obtain desired resonant intervals.

### Transformer Advantages

The transformer of present invention has the ideal full bi-directional flux capability illustrated in FIG. 27b. This transformer conducts the current during both intervals and results in best utilization of the windings, which transfer power all the time. Furthermore this transformer does not need a voltage-reset circuit, as the transformer is automatically volt-second balanced by two capacitors Cᵣ₁ and Cᵣ₂. Therefore, there is no net DC current flowing into either primary or secondary winding of the transformer, thus no DC-bias. Hence it does not store DC energy so it is built on an ungapped magnetic core resulting in large magnetizing inductance and small magnetizing current. In contrast, the transformer of the forward converter results in only unidirectional flux capability. Furthermore, the transformer of the forward converter has AC flux at least 4 times to 10 times larger than in present invention. Thus, that is one reason why this converter will result in much reduced size of the transformer. However, there is a yet another reason: elimination of losses due to transformer leakage inductance.

### Elimination of Losses of Leakage Inductance of the Transformer

The energy stored in the leakage inductance L₁ of the isolation transformer was given by (2). This energy is in conventional converters lost and results in undesirable large spike voltages on the switches, which have to be suppressed by use of lossy dissipative snubbers. In the present invention, the leakage inductance does not present a problem and it is a part of solution. Note how the two external resonant inductors operate in respective intervals in series with the transformer leakage inductance. Due to the two resonant current intervals, the leakage inductance current increases in resonant fashion at the beginning of each interval, but it is then returned to zero current level before end of the each interval, thus fully returning its stored energy to the converter during both ON-time interval and OFF-time interval. Another side benefit is the elimination of the need for dissipative snubbers to eliminate the spikes due to energy stored in leakage inductance. This then makes possible reduction of magnetics by operating at higher switching frequencies as the leakage inductance losses are eliminated.

### Integrated Magnetics Extension

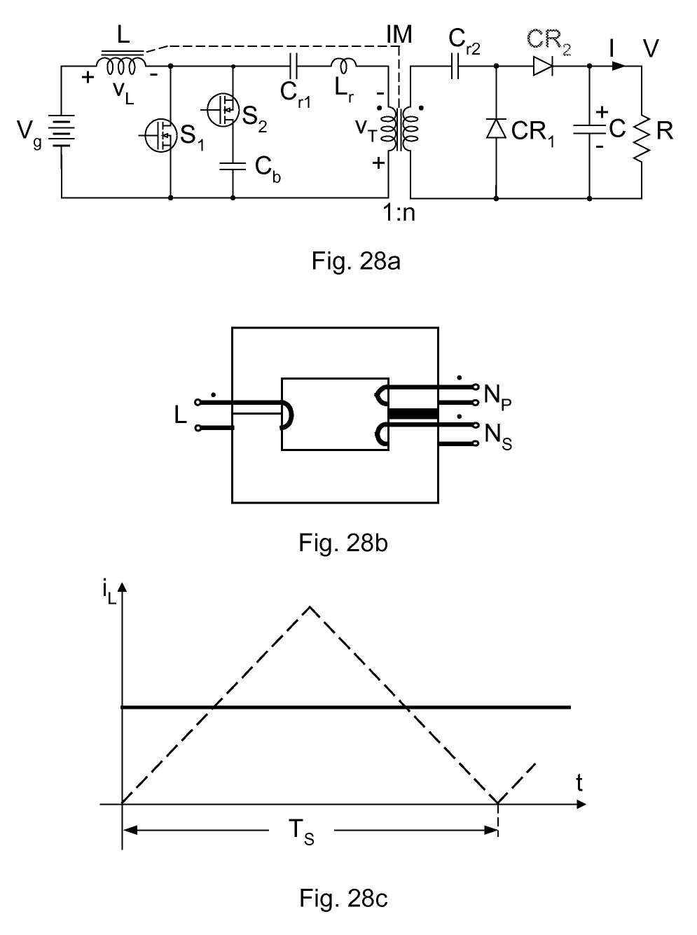

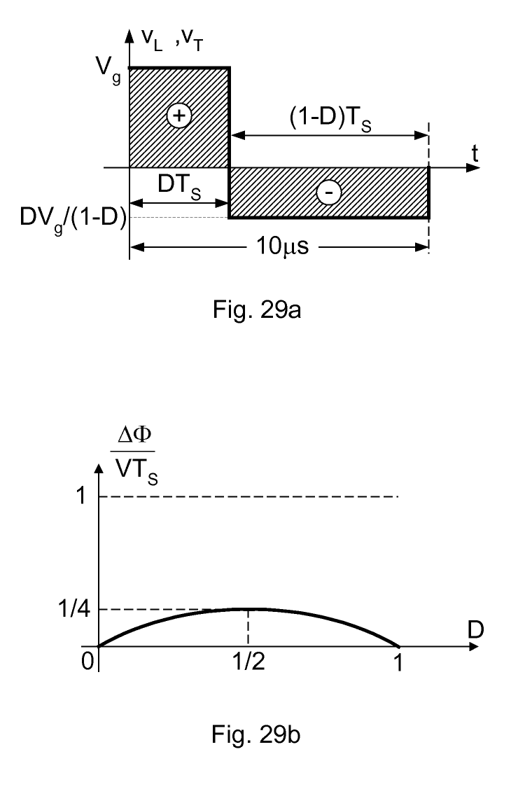

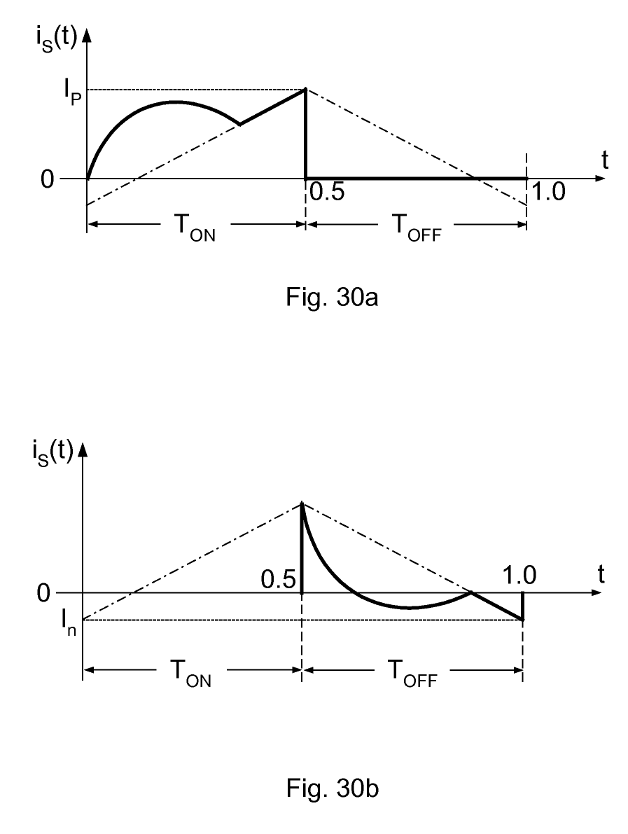

The converter in FIG. 27a has the identical AC voltages on the transformer and input inductor for any operating duty ratio D (FIG. 29a), which results in the Integrated Magnetics extension of FIG. 28a. Hence the transformer and input inductor can be combined on a single Integrated Magnetics structure of the UU-core type shown in FIG. 28b. This integration of magnetics results in further size reduction and core loss reduction, while at the same time improving the input ripple current, which with proper design can be made even ripple-free, despite finite core inductance, as illustrated in zero input ripple current waveform of FIG. 28c. The only condition is that the air-gap is placed in the magnetic leg with transformer windings and that input inductor and primary of the transformer should have the same number of turns.

The identical voltage waveforms of the inductor and transformer primary are shown in FIG. 29a. Therefore, the transformer flux shown in FIG. 29b preserves the same desirable flux per turn characteristic of the input inductor given by (1). Hence another objective of present invention to preserve the desirable flux characteristic of the boost converter inductor is achieved.

### Zero Voltage Switching of High Voltage Switches on Primary Side

The switches on the high voltage primary side have a parasitic drain to source capacitances C_{S1} and C_{S2} which result in large switching losses proportional to switching frequency as given by

P_{SW}=½C_{S}V_{S1}²f_{S} (38)

where C_{S} is a drain to source parasitic capacitance of the switches and V_{S1} is a voltage on the switch S₁when switch is OFF.

The switching losses on each switch can be much reduced by providing the dead time between the two switching transitions such that the energy stored on two parasitic capacitances is exchanged in a non-dissipative way during each transition as described next.

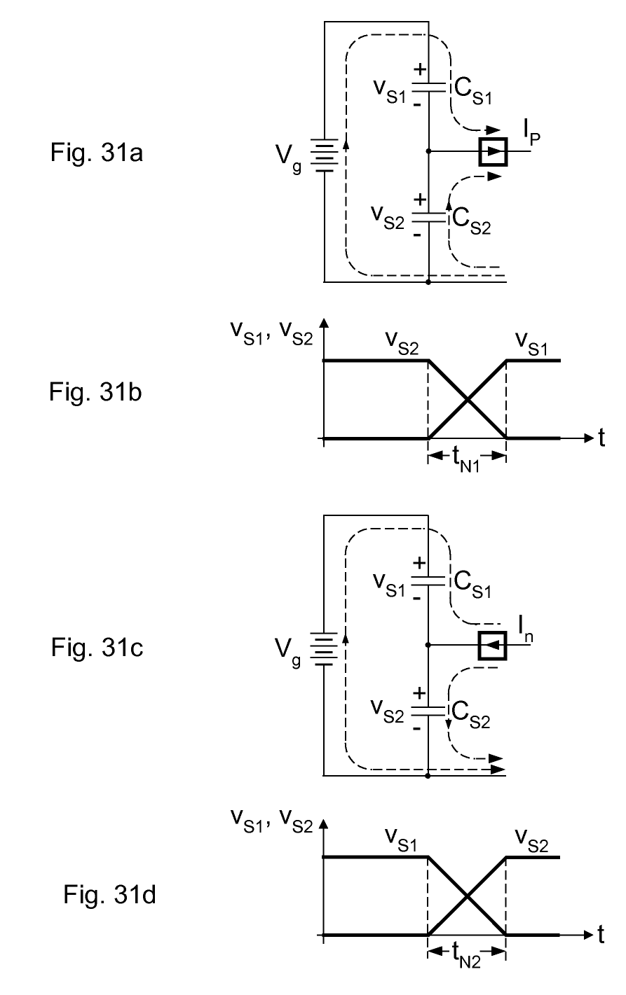

The switch current S₁ is shown in FIG. 31a to consist of both resonant current part and input inductor current part as it is sum of the two current waveforms. On the other hand, the current in switch S₂ is an AC current as it consists of the difference between the input inductor current and resonant discharge current and is shown in FIG. 31b, which also illustrates the case when the instantaneous current at the end of the OFF-time interval has a negative value.

At the first transition from the ON-time interval to the OFF-time interval, the capacitor charging current is I_{P} (FIG. 31a) so that the drain-to-source capacitance of the S₂ is linearly discharged to zero (actually its charge transferred to the drain to source capacitance of open switch S₁) so that switch S₂ can be turned ON at zero voltage and hence with no switching losses. The opposite takes place during the transition from OFF-time interval to ON-time interval. The current at the end of the OFF-time interval is represented by a current source I_{N} flowing in opposite direction as seen in FIG. 31c so that the drain to source capacitance of switch S₁ is now discharging until reaches zero voltage (FIG. 31d) at which time it is turned ON with no switching losses. Its charge is transferred to the drain to source capacitance of the switch S₂.

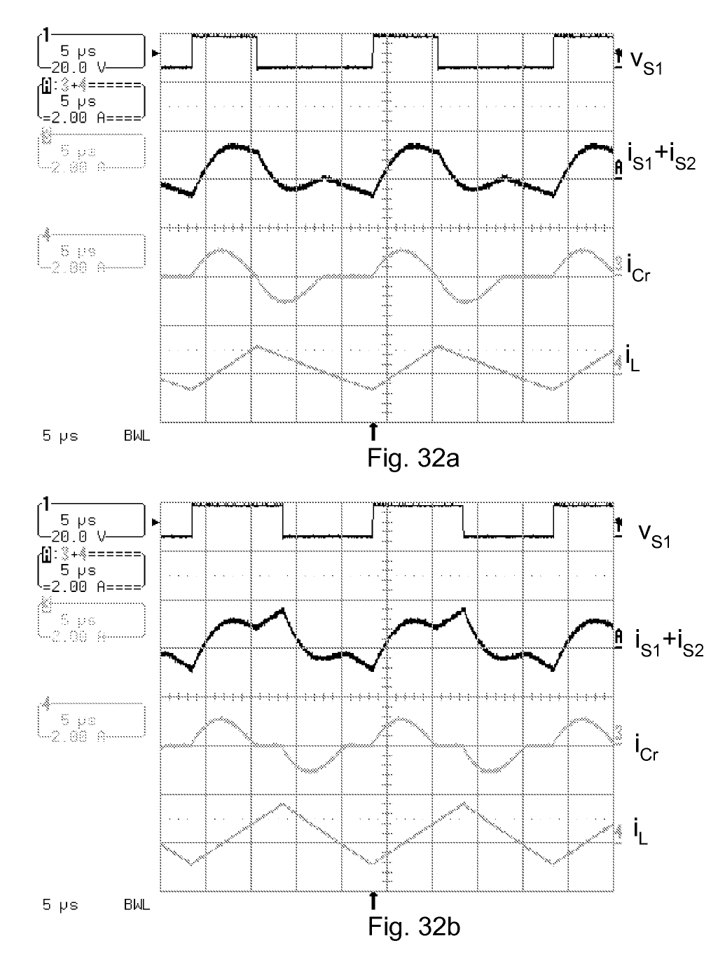

The experimental waveforms in FIG. 32a and FIG. 32b confirm the positive and negative currents at the transition intervals. The Half-bridge Rectifier Extension

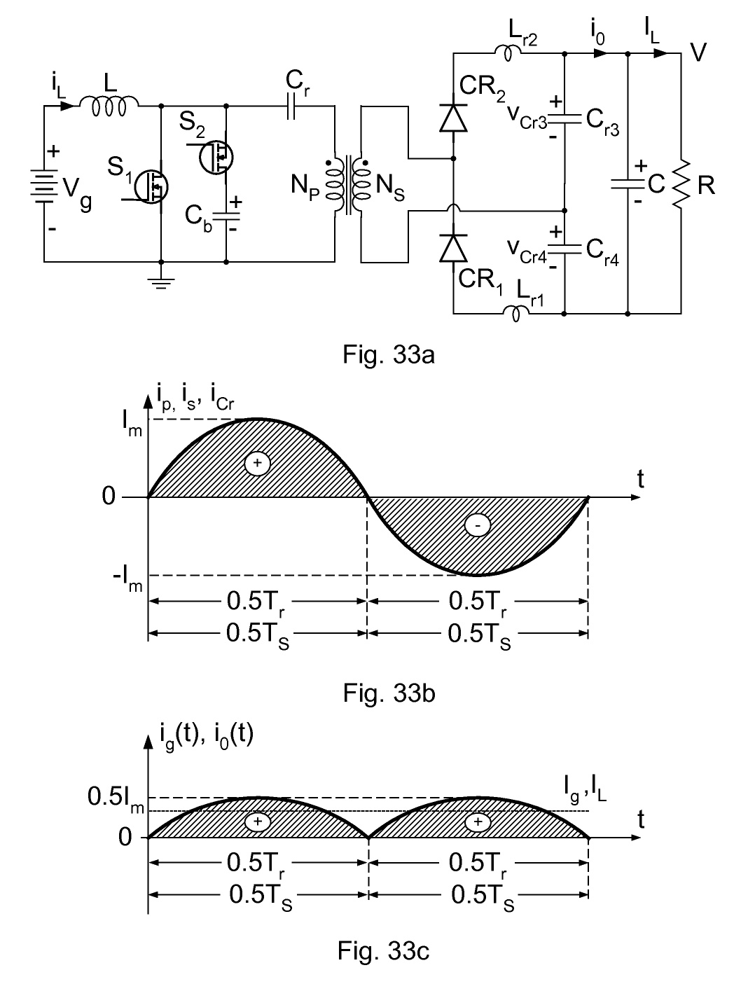

The secondary side can be configured as a half-bridge rectifier as illustrated in FIG. 33a with resonant capacitors Cᵣ₃ and Cr4, which have in steady state DC voltages given by:

V_{Cr3}=V_{g} (39)

V_{Cr4}=V_{g}D/(1=D) (40)

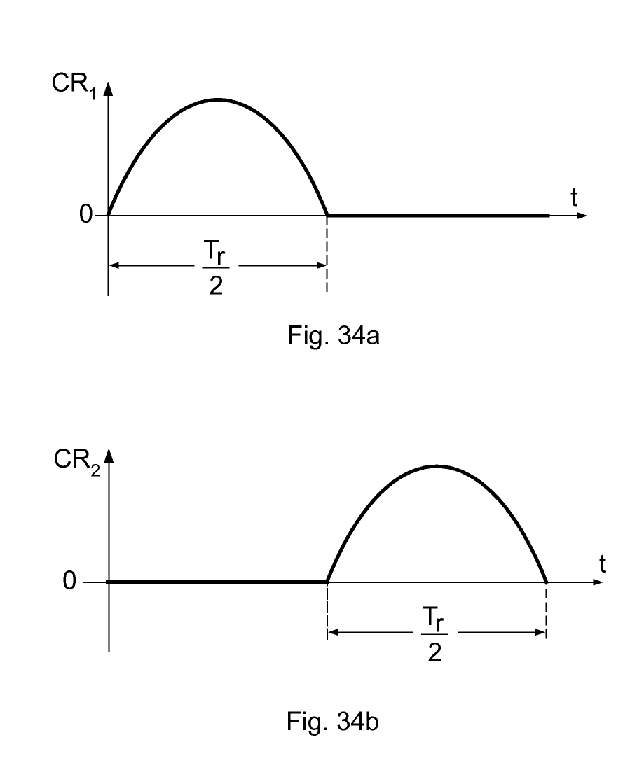

thus resulting in unchanged output DC voltage V_{g} /(1−D) equal to the sum of (32) and (33). For a special case of D=0.5, it is illustrated in FIG. 33b, how the resonant transformer current is split between the two resonant capacitors on the output, to result in the load current i₀ as shown in FIG. 33c. This results in the output current being continuous and helps reduce the size of the output filtering capacitor C. The waveforms in FIG. 34a and FIG. 34b illustrate that the current rectifiers CR₁ and CR₂ are both turned ON and turned OFF at zero current level as dictated by the respective resonant inductors in their branches.

### Transformer Step-Up Application

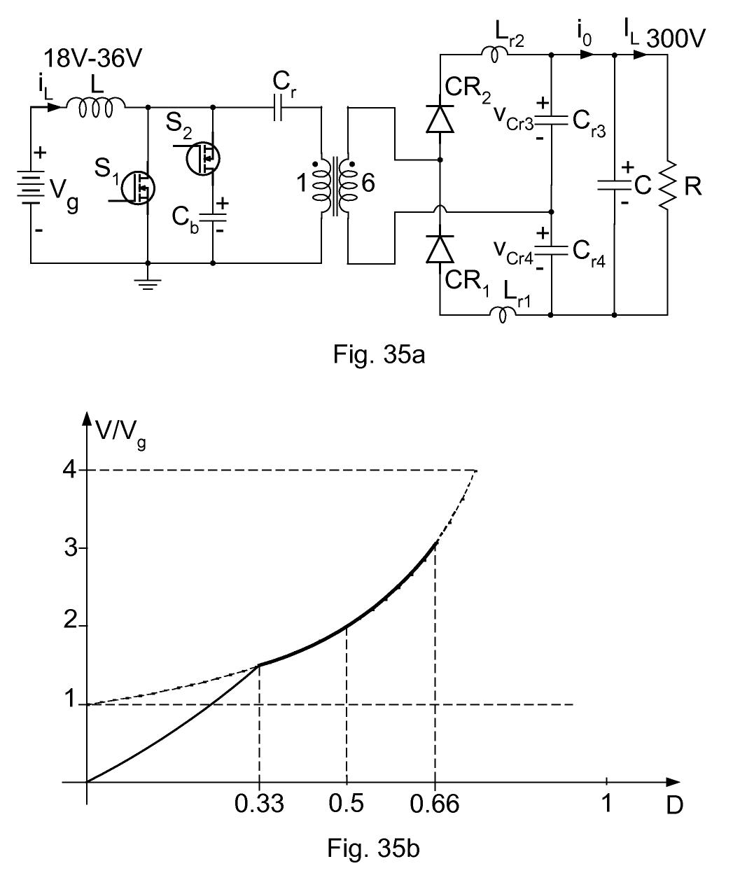

The main applications of the present invention is for step-up voltage applications in which step-up voltage is achieved through both duty ratio increase as well as through the transformer step-up turns ratio. Shown in FIG. 35a is an example in which the input voltage in the 18V to 36V range is stepped-up to 300V and regulated. Note that large part of voltage step-up is accomplished through duty ratio D control so that only additional 1:6 step-up turns ratio of the transformer is needed. The corresponding DC gain characteristic is shown in heavy lines in FIG. 35b.

### Another Embodiment With the Isolation Transformer

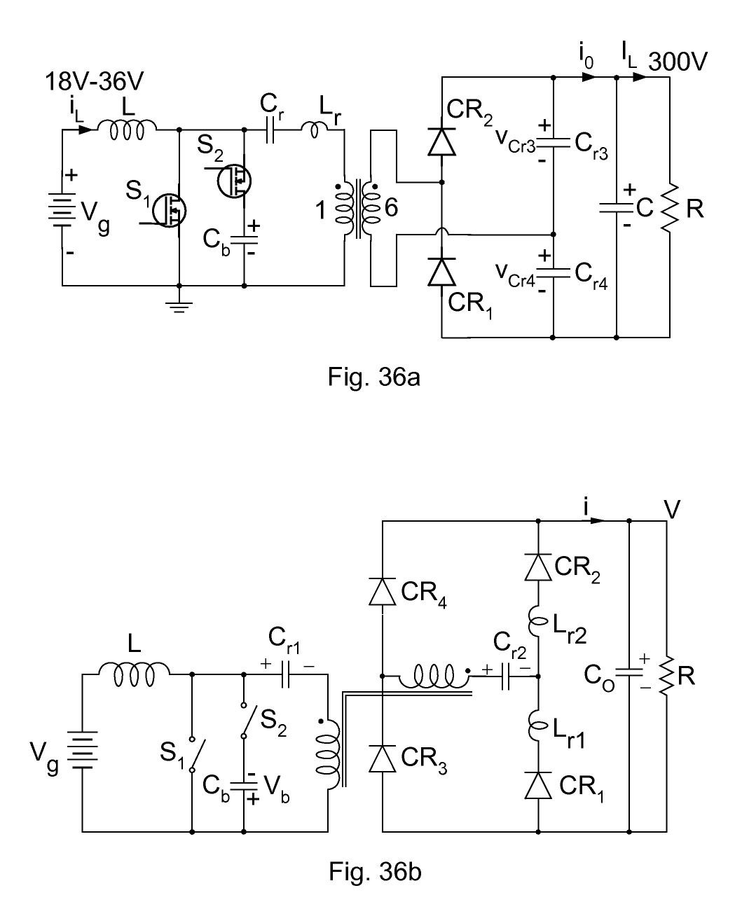

FIG. 36a shows yet another step-up embodiment of the present invention in FIG. 7a in which the resonant inductor is placed on the primary side of the isolation transformer and in series with the primary side resonant capacitor. Then either one or both of two resonant inductors in the branches with the output current rectifiers can be shorted and eliminated. In another embodiment the resonant inductor Lr in FIG. 36a can be itself shorted and its role played by the leakage inductance of the isolation transformer. Clearly in that case, the resonant capacitor on primary side must be chosen appropriately to result in desired resonant intervals and efficient converter operation, which has half-wave sinusoidal resonant capacitor currents. The resonant equations described earlier are then used to determine the value of the resonant capacitor, which is needed to result in half-wave sinusoidal resonant currents whose resonant conduction periods should be equal to 0.33 T_{S} so as to provide for 2:1 input voltage change and the best method of duty ratio D control as described next.

### Constant ON-Time And Variable OFF-Time Control

If the ON-time of the main switch S₁ is kept constant and equal to half of a first resonant period, then the resonant discharge current waveform will be exactly half a sine wave. The output voltage is then controlled by change of the OFF-time interval, or effectively change of the switching frequency.

There are several benefits in operating in this mode. The rms current of a sine-wave current is only 11% higher than the rms value of the average current during the same interval. Therefore the rms current (and the corresponding power loss) in the resonant circuit (including S₁, CR₁, the resonant capacitor Cᵣ and the resonant inductor Lᵣ₁) will be significantly lower than if the circuit is discharged with a current waveform with higher rms current due to the presence of the coasting interval.

The ON-time is kept constant as per:

T_{ON}=DTₛ=T_{R1}=constant (41)

so that duty ratio is proportional to switching frequency, or:

D=0.5f_{S}/fᵣ₁ (42)

Thus, voltage regulation is obtained by use of the variable switching frequency f_{S}. However, this results in corresponding duty ratio D as per (42). Note that all DC quantities, such as DC voltages on capacitors and DC currents of inductors are still represented as a function of duty ratio D only, as in the case of conventional constant-switching frequency operation.

### The Full-Bridge Rectifier Embodiment

The secondary side can be configured as a full-bridge rectifier with four rectifiers as shown in FIG. 36b.

### Current Bi-Directional Embodiment

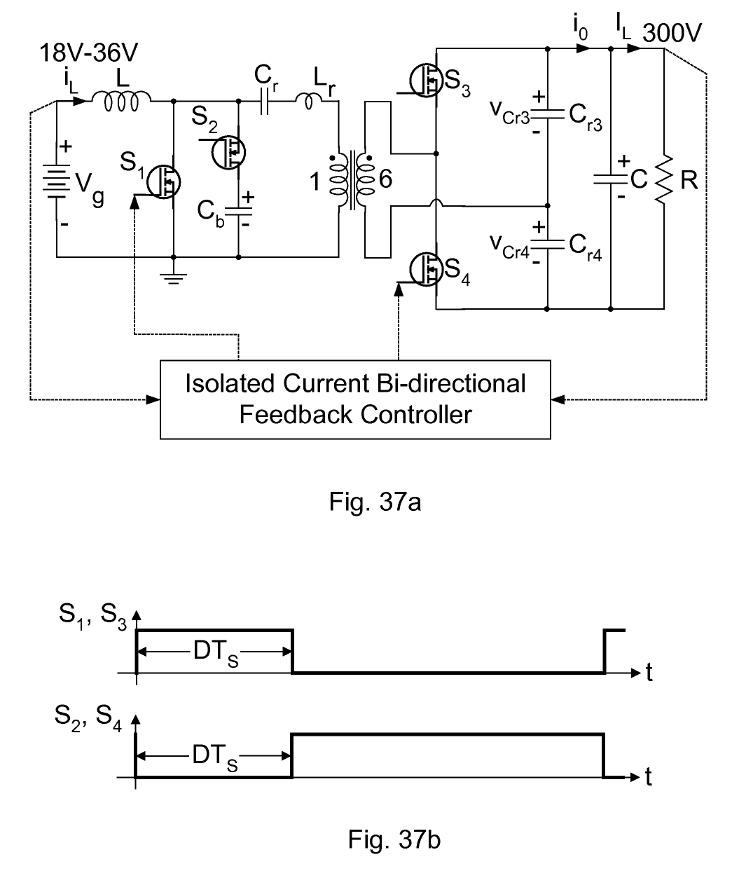

Shown in FIG. 37a is the current bi-directional embodiment, capable to transfer the power in either direction based on the feedback controller direction. Note that the output current rectifiers are replaced by synchronous rectifier MOSFETs. This makes the whole converter current bi-directional and allows power flow in either direction depending of the feedback controller. The switch states for four MOSFETs are shown in FIG. 37b.

### Step-Down Application

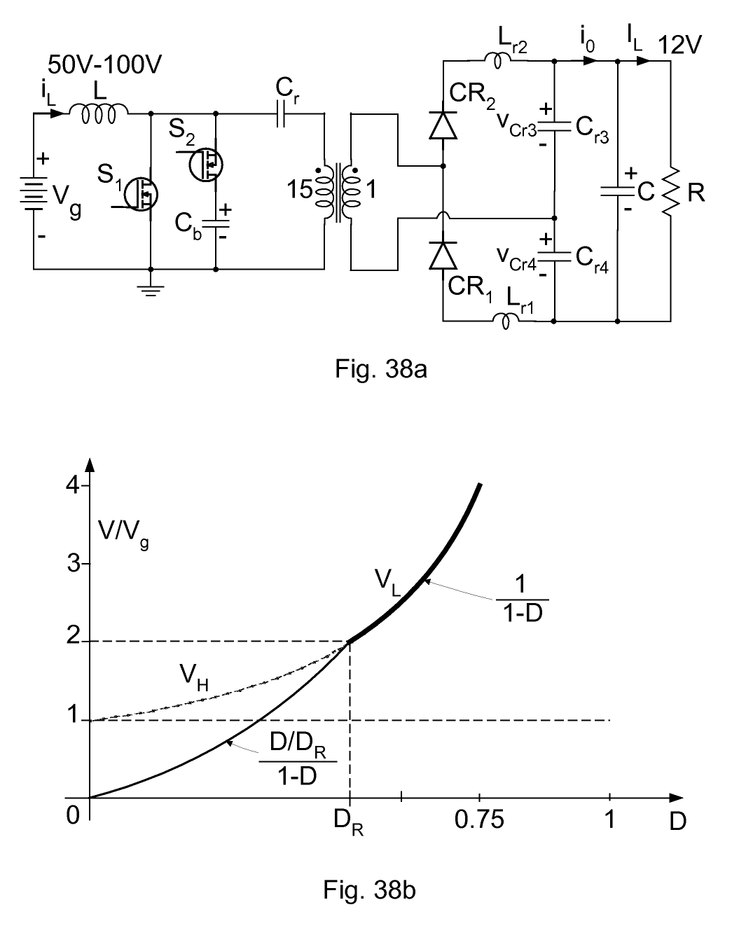

The present invention can also be applied to step-down applications by using the transformer turns ratio to step-down the input voltage (FIG. 38a), such as from 100V input to 12V output as illustrated by the operating range shown in heavy lines in FIG. 38b. The main advantage of such an operation is that the regulation of the output voltage over the wide input voltage range can be obtained, while all the switches have the same low voltage stresses equal to either output voltage or reflected output voltage through the turns ratio of transformer.

### Zero Voltage Switching Verification

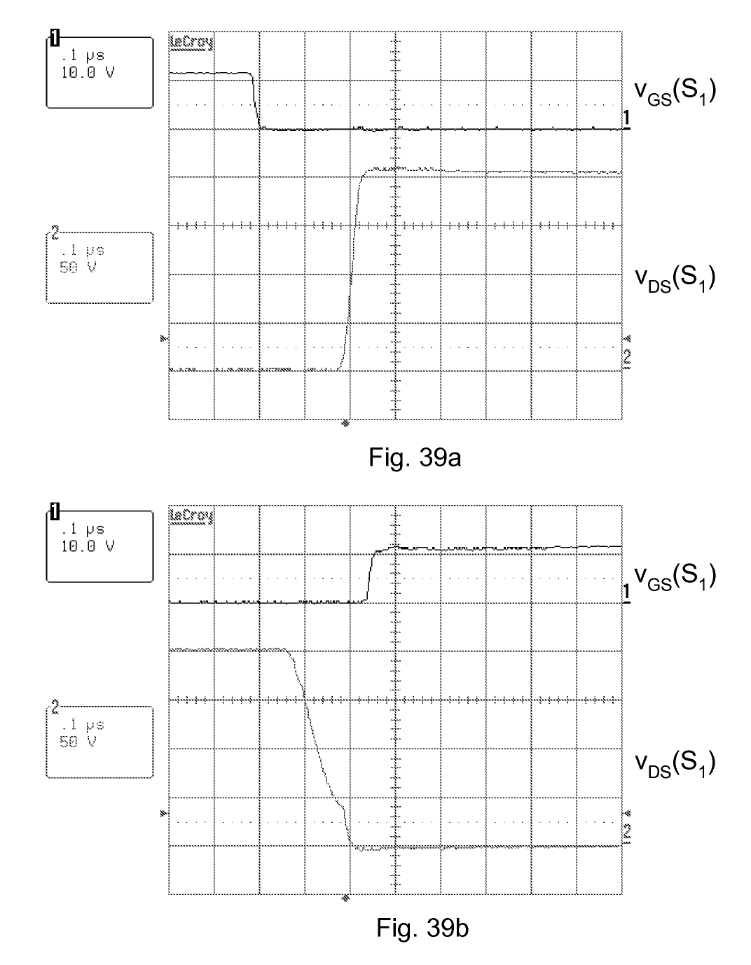

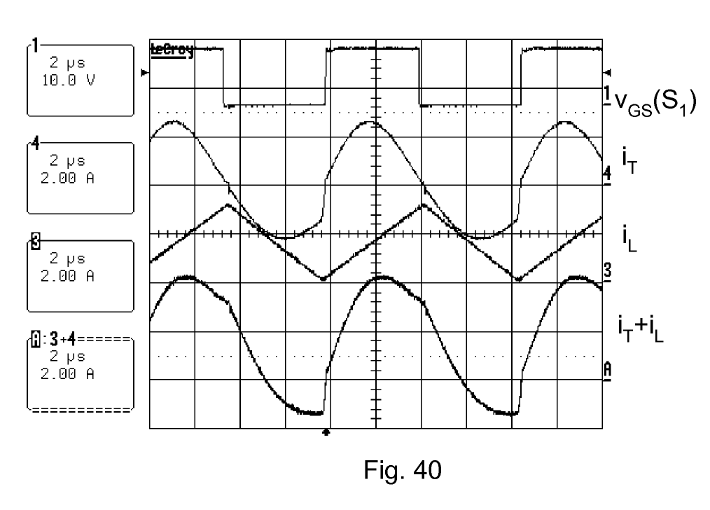

The expanded transition intervals shown in FIG. 39a and FIG. 39b demonstrate the voltages on the primary side switches with the linear transitions and the respective gate drive voltages confirming that the devices are turned ON when the voltage on them has been reduced to zero or very close to zero. This was obtained with the current waveforms shown in FIG. 40.

### Other Embodiments With Pulsating Input Current

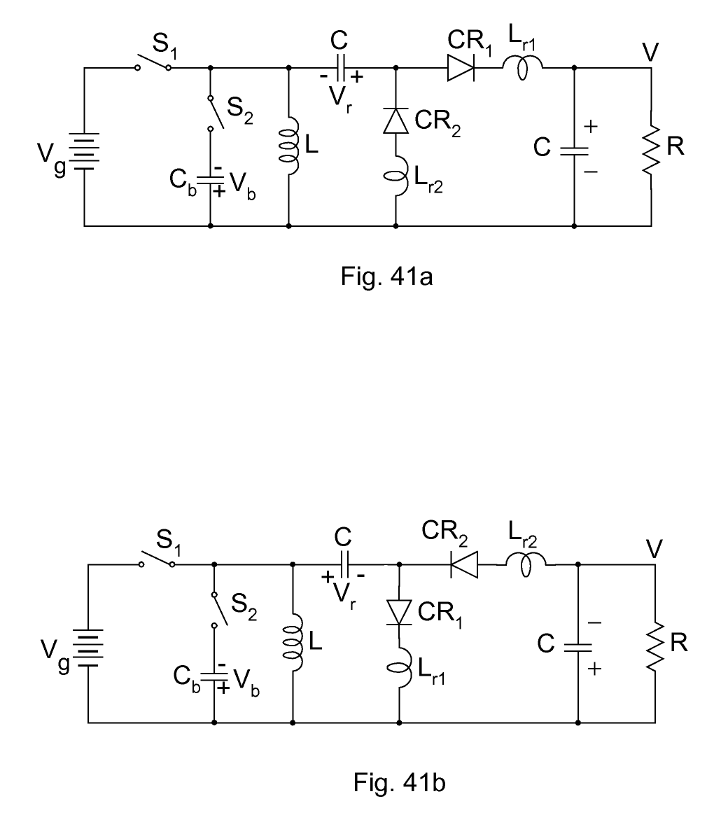

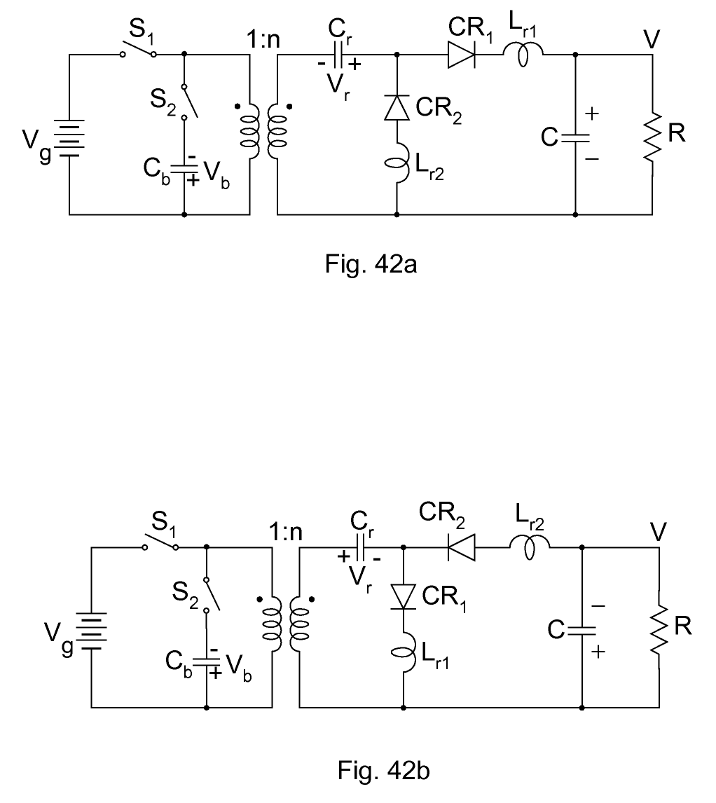

The previous non-isolated and isolated extensions of the step-up converters had an input inductor. Here several extensions are introduced in which the input inductor is relocated such as shown in FIG. 41a and FIG. 41b. Both configurations feature the resonant ON-time interval and PWM OFF-time interval. The converters in FIG. 42a and FIG. 42b can be easily converted into isolated counter-parts by replacing the inductor with a two winding isolation transformer as shown in FIG. 42a and FIG. 42b, thus eliminating one inductor compared to converters on FIG. 7a However, this isolation transformer does have a DC bias and it is recommended for lower power levels.

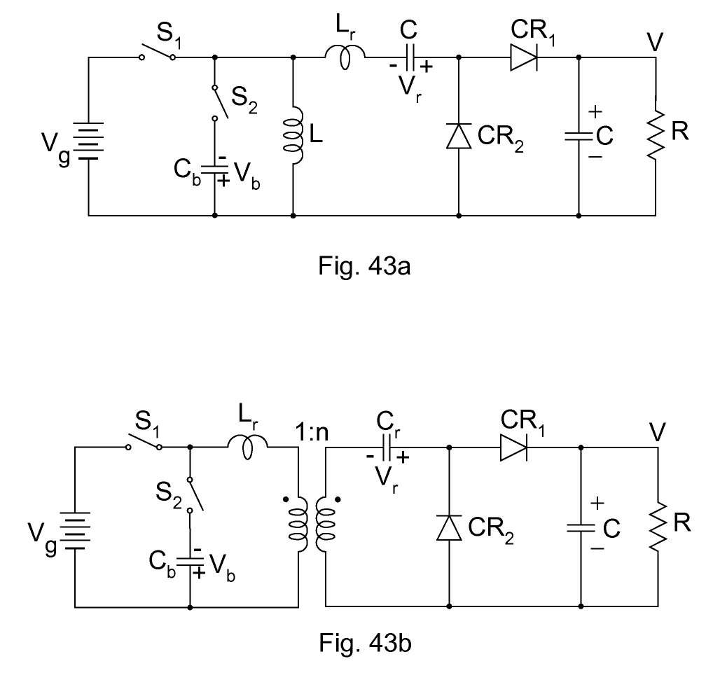

Another nonisolated embodiment shown in FIG. 43a has a single resonant inductor in series with the resonant capacitor and no resonant inductors in rectifier branches.

Finally another isolated embodiment in FIG. 43b has a single resonant inductor in series with the transformer primary and no resonant inductors in current rectifier branches.

### Half-Bridge And Full-Bridge Extensions

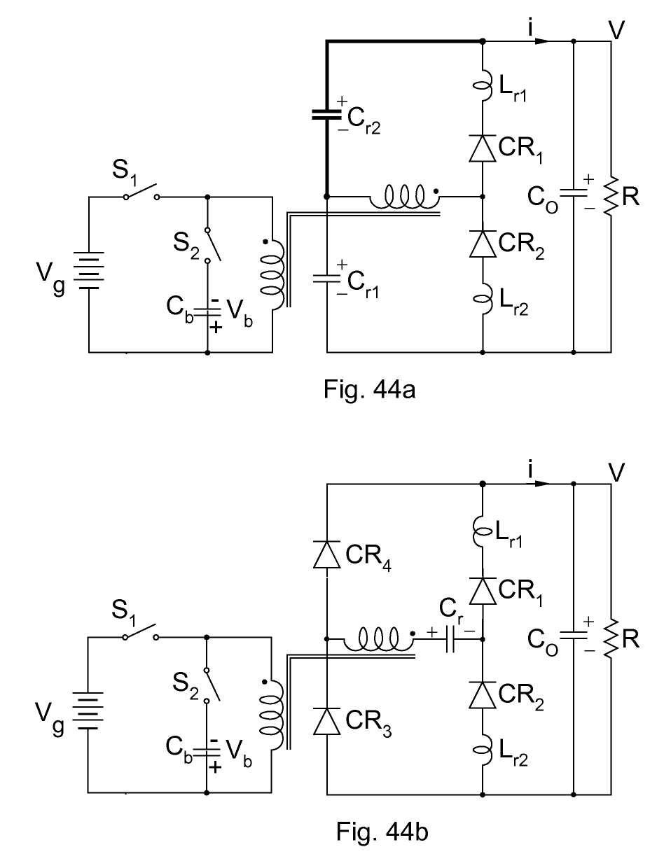

Following the same procedure as described previously, the half-bridge and full-bridge secondary side rectification can be implemented as illustrated in FIG. 44a and FIG. 44b. The same advantages as described for previous embodiments apply.

### Conclusion

A switching converter is introduced, which features four switches and eliminates the losses due to energy stored in transformer leakage inductance. The converter has a low voltage stresses on all switches: the secondary side switches have voltage stresses equal to the output voltage, and primary side switches have the stresses proportional to output voltage and turns ratio of transformer. Therefore, the converter can operate over the wide input voltage range with the same low voltage stresses on all switching devices. Despite the two distinct and independently controlled resonant current intervals, the output DC voltage is controlled solely by the duty ratio D control and not using the resonant control methods.

### REFERENCES

1. Slobodan Cuk, R. D. Middlebrook, “Advances in Switched-Mode Power Conversion”, Vol. 1, II, and III, TESLAco 1981 and 1983.

What is claimed is:

1. A non-isolated switching DC-to-DC converter for providing power from a DC voltage source connected between an input terminal and a common terminal to a DC load connected between an output terminal and said common terminal, said converter comprising:
an input inductor connected at one end to said input terminal;
a first switch with one end connected to said common terminal and another end connected to another end of said input inductor;
a second switch with one end connected to said another end of said input inductor;
a boost capacitor connected at one end to said common terminal and another end connected to another end of said second switch;
a resonant capacitor connected at one end to said another end of said input inductor;
a first resonant inductor connected at one end to said common terminal;
a second resonant inductor connected at one end to said output terminal;
a first current rectifier with an anode end connected to another end of said first resonant inductor and a cathode end connected to another end of said resonant capacitor;
a second current rectifier with an anode end connected to another end of said resonant capacitor and a cathode end connected to another end of said second resonant inductor;
an output capacitor with one end connected to said output terminal and another end connected to said common terminal;
switching means for keeping said first switch ON and said second switch OFF for a duration of an ON-time interval DT_{S}, and keeping said first switch OFF and said second switch ON for a duration of an OFF-time interval D′T_{S}, where D is a duty ratio and D′ is a complementary duty ratio within one complete and constant switch operating cycle T_{S};
wherein said first switch and said second switch can be implemented with active semiconductor switching devices such as MOSFET transistors;
wherein said first resonant inductor and said resonant capacitor form a first resonant circuit during said ON-time interval and define a constant first resonant conduction period T_{R1};
wherein said second resonant inductor and said resonant capacitor form a second resonant circuit during said OFF-time interval and define a constant second resonant conduction period T_{R2};
wherein turn-ON of said first switch causes a turn-ON of said first rectifier at zero current level and a first sinusoidal resonant current flows through said first current rectifier until it reaches a zero current level again and turns OFF said first rectifier making said first resonant conduction period T_{R1} equal to or smaller than said ON-time interval;
wherein turn-ON of said second switch causes a turn-ON of said second rectifier at zero current level and a second sinusoidal resonant current flows through said second current rectifier until it reaches a zero current level again and turns OFF said second rectifier making said second resonant conduction period T_{R2} equal to or smaller than said OFF-time interval;
whereby said first rectifier is turned ON and turned OFF at zero current with no switching losses;
whereby said second rectifier is turned ON and turned OFF at zero current with no switching losses;
whereby an output voltage between said output terminal and said common terminal is regulated by controlling said ON-time interval of said first switch;
whereby said converter has a step-down/step-up voltage gain characteristic when said duty ratio D is smaller than a resonant duty ratio D_{R} for which said first resonant conduction period T_{R1} is equal to said ON-time interval;
whereby said converter has a step-up voltage gain characteristic when said duty ratio D is equal or bigger than said resonant duty ratio D_{R};
whereby voltage stresses on said first switch, said second switch, said first current rectifier, and said second current rectifier are equal to said output voltage, and
whereby said output voltage has the same polarity as said DC voltage source.

2. A converter as defined in claim 1,
wherein one end of a first branch with series connection of said first rectifier and said first resonant inductor is disconnected from said common terminal and connected to said output terminal;
wherein one end of a second branch with series connection of said second rectifier and said second resonant inductor is disconnected from said output terminal and connected to said common terminal, and
whereby said output voltage has the opposite polarity of said DC voltage source.

3. A converter as defined in claim 1,
wherein said ON-time interval DT_{S} is constant and equal to said first resonant conduction period T_{R1}, and
whereby said output voltage is controlled by change of said OFF-time interval D′T_{S}.

4. A converter as defined in claim 1,
wherein said first resonant inductor is shorted;
wherein said second resonant inductor is shorted, and
wherein a resonant inductor is connected in series with said resonant capacitor.

5. A converter as defined in claim 1,
wherein said one end of said input inductor is disconnected from said input terminal and connected to said common terminal;
wherein said one end of said first switch is disconnected from said common terminal and connected to said input terminal;
wherein a first branch with series connection of said first rectifier and said first resonant inductor is connected between said output terminal and said another end of said resonant capacitor;
wherein a second branch with series connection of said second rectifier and said second resonant inductor is connected between said common terminal and said another end of said resonant capacitor, and
whereby said output voltage has the same polarity as said DC voltage source.

6. A converter as defined in claim 5,
wherein one end of said first branch with series connection of said first rectifier and said first resonant inductor is disconnected from said output terminal and connected to said common terminal;
wherein one end of said second branch with series connection of said second rectifier and said second resonant inductor is disconnected from said common terminal and connected to said output terminal, and
whereby said output voltage has the opposite polarity of said DC voltage source;

[symbol]

7. An isolated switching DC-to-DC converter for providing power from a DC voltage source connected between an input terminal and a common input terminal to a DC load connected between an output terminal and a common output terminal, said converter comprising:
an isolation transformer with a primary winding and a secondary winding, each winding having one dot-marked end and another unmarked end whereby any AC voltage applied to said primary winding of said isolation transformer induces AC voltage in said secondary winding of said isolation transformer so that two AC voltages are in phase at dot-marked ends of said primary and secondary windings of said isolation transformer;
said primary winding of said isolation transformer connected at said unmarked end thereof to said common input terminal;
said secondary winding of said isolation transformer connected at said unmarked end thereof to said common output terminal;
a first resonant capacitor connected at one end to said dot-marked end of said primary winding of said isolation transformer;
an input inductor connected at one end to said input terminal and another end connected to said first resonant capacitor at another end thereof;
a first switch with one end connected to said common input terminal and another end connected to said another end of said input inductor;
a second switch with one end connected to said another end of said input inductor;
a boost capacitor connected at one end to said common input terminal and another end connected to another end of said second switch;
a second resonant capacitor connected at one end to said dot-marked end of said secondary winding of said isolation transformer;
a first resonant inductor connected at one end to said common output terminal;
a second resonant inductor connected at one end to said output terminal;
a first current rectifier with an anode end connected to another end of said first resonant inductor and a cathode end connected to another end of said second resonant capacitor;
a second current rectifier with an anode end connected to another end of said second resonant capacitor and a cathode end connected to another end of said second resonant inductor;
an output capacitor with one end connected to said output terminal and another end connected to said common output terminal;
switching means for keeping said first switch ON and said second switch OFF for a duration of an ON-time interval DT_{S}, and keeping said first switch OFF and said second switch ON for a duration of an OFF-time interval D′T_{S}, where D is a duty ratio and D′ is a complementary duty ratio within one complete and constant switch operating cycle T_{S};
wherein said isolation transformer does not have a DC-bias and does not have an air-gap;
wherein said primary winding and said secondary winding are tightly coupled for reduced leakage;
wherein said first switch and said second switch can be implemented with active semiconductor switching devices such as MOSFET transistors;
wherein said first resonant inductor, said first resonant capacitor, and said second resonant capacitor form a first resonant circuit during said ON-time interval and define a constant first resonant conduction period T_{R1};
wherein said second resonant inductor, said first resonant capacitor, and said second resonant capacitor form a second resonant circuit during said OFF-time interval and define a constant second resonant conduction period T_{R2};
wherein turn-ON of said first switch causes a turn-ON of said first rectifier at zero current level and a first sinusoidal resonant current flows through said first current rectifier until it reaches a zero current level again and turns OFF said first rectifier making said first resonant conduction period T_{R1} equal to or smaller than said ON-time interval;
wherein turn-ON of said second switch causes a turn-ON of said second rectifier at zero current level and a second sinusoidal resonant current flows through said second current rectifier until it reaches a zero current level again and turns OFF said second rectifier making said second resonant conduction period T_{R2} equal to or smaller than said OFF-time interval;
whereby said first rectifier is turned ON and turned OFF at zero current with no switching losses;
whereby said second rectifier is turned ON and turned OFF at zero current with no switching losses;
whereby an output voltage between said output terminal and said common output terminal is regulated by controlling said ON-time interval of said first switch;
whereby said converter has a step-down/step-up voltage gain characteristic when said duty ratio D is smaller than a resonant duty ratio D_{R} for which said first resonant conduction period T_{R1} is equal to said ON-time interval;
whereby said converter has a step-up voltage gain characteristic when said duty ratio D is equal or bigger than said resonant duty ratio D_{R};
whereby a turns ratio of said secondary winding to said primary winding of said isolation transformer provides additional scaling of said DC-to-DC voltage conversion ratio of said converter;
whereby voltage stresses on said first current rectifier and said second current rectifier are equal to said output voltage, and
whereby voltage stresses on said first switch and said second switch are equal to said output voltage divided by said turns ratio of said isolation transformer.

8. A converter as defined in claim 7,
wherein said ON-time interval DT_{S} is constant and equal to said first resonant conduction period T_{R1}, and
whereby said output voltage is controlled by change of said OFF-time interval D′T_{S}.

9. A converter as defined in claim 7,
wherein said first resonant inductor is shorted;
wherein said second resonant inductor is shorted, and
wherein a resonant inductor is connected in series with said resonant capacitor.

10. A converter as defined in claim 7,
wherein said input inductor and said isolation transformer are coupled on a common magnetic UU-type magnetic core to form an Integrated Magnetics structure;
wherein said Integrated Magnetics structure has a DC bias and an air-gap is introduced in one leg of said UU-type magnetic core to prevent magnetic flux saturation;
wherein said primary winding and said secondary winding of said isolation transformer are placed on a magnetic leg with said air-gap, while said input inductor winding is placed on a magnetic leg without said air-gap, so that a ripple current of said input inductor is shifted into said isolation transformer, thus significantly reducing a conducted input noise, and
whereby said Integrated Magnetics structure is both smaller and more efficient than two separate magnetic structures of said input inductor and said isolation transformer it replaces.

11. A converter as defined in claim 7,
wherein one end of a first branch with series connection of said first rectifier and said first resonant inductor is disconnected from said common output terminal and connected to said output terminal;
wherein one end of a second branch with series connection of said second rectifier and said second resonant inductor is disconnected from said output terminal and connected to said common output terminal, and
whereby said output voltage has the opposite polarity of said DC voltage source.

12. A converter as defined in claim 7,
wherein said second resonant capacitor is shorted;
wherein a third resonant capacitor is connected with one end to said output terminal;
wherein a fourth resonant capacitor is connected with one end to another end of said third resonant capacitor and with another end thereof to said common output terminal;
wherein said unmarked end of said secondary winding of said isolation transformer is disconnected from said common output terminal and connected to said one end of said fourth resonant capacitor;
whereby said DC load is supplied by current during both said ON-time interval DT_{S} and said OFF-time interval D′T_{S} to increase efficiency of said converter, and
whereby size and ripple current requirements of said output capacitor are substantially reduced.

13. A converter as defined in claim 7,
wherein a third current rectifier is connected with an anode end to said common output terminal;
wherein a fourth current rectifier is connected with a cathode end to said output terminal and with an anode end to a cathode end of said third current rectifier;
wherein said unmarked end of said secondary winding of said isolation transformer is disconnected from said common output terminal and connected to said cathode end of said third current rectifier;
whereby said DC load is supplied by current during both said ON-time interval DT_{S} and said OFF-time interval D′T_{S} to increase efficiency of said converter, and
whereby size and ripple current requirements of said output capacitor are substantially reduced.

14. An isolated switching DC-to-DC converter for providing power from a DC voltage source connected between an input terminal and a common input terminal to a DC load connected between an output terminal and a common output terminal, said converter comprising:
an isolation transformer with a primary winding and a secondary winding, each winding having one dot-marked end and another unmarked end whereby any AC voltage applied to said primary winding of said isolation transformer induces AC voltage in said secondary winding of said isolation transformer so that two AC voltages are in phase at dot-marked ends of said primary and secondary windings of said isolation transformer;
said primary winding of said isolation transformer connected at an unmarked end thereof to said common input terminal;
said secondary winding of said isolation transformer connected at an unmarked end thereof to said common output terminal;
a first switch with one end connected to said input terminal and another end connected to said dot-marked end of said primary winding of said isolation transformer;
a second switch with one end connected to said dot-marked end of said primary winding of said isolation transformer;
a boost capacitor connected at one end to said common input terminal and another end connected to another end of said second switch;
a resonant capacitor connected at one end to said dot-marked end of said secondary winding of said isolation transformer;
a first resonant inductor connected at one end to said output terminal;
a second resonant inductor connected at one end to said common output terminal;
a first current rectifier with a cathode end connected to another end of said first resonant inductor and an anode end connected to another end of said resonant capacitor;
a second current rectifier with a cathode end connected to another end of said resonant capacitor and an anode end connected to another end of said second resonant inductor;
an output capacitor with one end connected to said output terminal and another end connected to said common output terminal;
switching means for keeping said first switch ON and said second switch OFF for a duration of an ON-time interval DT_{S}, and keeping said first switch OFF and said second switch ON for a duration of an OFF-time interval D′T_{S}, where D is a duty ratio and D′ is a complementary duty ratio within one complete and constant switch operating cycle T_{S};
wherein said primary winding and said secondary winding are tightly coupled for reduced leakage;
wherein said first switch and said second switch can be implemented with active semiconductor switching devices such as MOSFET transistors;
wherein said first resonant inductor and said resonant capacitor form a first resonant circuit during said ON-time interval and define a constant first resonant conduction period T_{R1};
wherein said second resonant inductor and said resonant capacitor form a second resonant circuit during said OFF-time interval and define a constant second resonant conduction period T_{R2};
wherein turn-ON of said first switch causes a turn-ON of said first rectifier at zero current level and a first sinusoidal resonant current flows through said first current rectifier until it reaches a zero current level again and turns OFF said first rectifier making said first resonant conduction period T_{R1} equal to or smaller than said ON-time interval;
wherein turn-ON of said second switch causes a turn-ON of said second rectifier at zero current level and a second sinusoidal resonant current flows through said second current rectifier until it reaches a zero current level again and turns OFF said second rectifier making said second resonant conduction period T_{R2} equal to or smaller than said OFF-time interval;
whereby said first rectifier is turned ON and turned OFF at zero current with no switching losses;
whereby said second rectifier is turned ON and turned OFF at zero current with no switching losses;
whereby an output voltage between said output terminal and said common output terminal is regulated by controlling said ON-time interval of said first switch;
whereby said converter has a step-down/step-up voltage gain characteristic when said duty ratio D is smaller than a resonant duty ratio D_{R} for which said first resonant conduction period T_{R1} is equal to said ON-time interval;
whereby said converter has a step-up voltage gain characteristic when said duty ratio D is equal or bigger than said resonant duty ratio D_{R};
whereby a turns ratio of said secondary winding to said primary winding of said isolation transformer provides additional scaling of said DC-to-DC voltage conversion ratio of said converter;
whereby voltage stresses on said first current rectifier and said second current rectifier are equal to said output voltage, and
whereby voltage stresses on said first switch and said second switch are equal to said output voltage divided by said turns ratio of said isolation transformer.

15. A converter as defined in claim 14,
wherein said ON-time interval DT_{S} is constant and equal to said first resonant conduction period T_{R1}, and
whereby said output voltage is controlled by change of said OFF-time interval D′T_{S}.

16. A converter as defined in claim 14,
wherein said first resonant inductor is shorted;
wherein said second resonant inductor is shorted, and
wherein a resonant inductor is connected in series with said resonant capacitor.

17. A converter as defined in claim 14,
wherein one end of a first branch with series connection of said first rectifier and said first resonant inductor is disconnected from said output terminal and connected to said common output terminal;
wherein one end of a second branch with series connection of said second rectifier and said second resonant inductor is disconnected from said common output terminal and connected to said output terminal, and
whereby said output voltage has the opposite polarity of said DC voltage source.

18. A converter as defined in claim 14,
wherein said resonant capacitor is shorted;
wherein a first resonant capacitor is connected with one end to said common output terminal;
wherein a second resonant capacitor is connected with one end to another end of said first resonant capacitor and with another end thereof to said output terminal;
wherein said unmarked end of said secondary winding of said isolation transformer is disconnected from said common output terminal and connected to said one end of said second resonant capacitor;
whereby said DC load is supplied by current during both said ON-time interval DT_{S} and said OFF-time interval D′T_{S} to increase efficiency of said converter, and
whereby size and ripple current requirements of said output capacitor are substantially reduced.

19. A converter as defined in claim 14,
wherein a third current rectifier is connected with an anode end to said common output terminal;
wherein a fourth current rectifier is connected with a cathode end to said output terminal and with an anode end to a cathode end of said third current rectifier;
wherein said unmarked end of said secondary winding of said isolation transformer is disconnected from said common output terminal and connected to said cathode end of said third current rectifier;
whereby said DC load is supplied by current during both said ON-time interval DT_{S} and said OFF-time interval D′T_{S} to increase efficiency of said converter, and
whereby size and ripple current requirements of said output capacitor are substantially reduced.

20. An isolated switching bi-directional DC-to-DC converter for providing power either from a DC voltage source connected between an input terminal and a common input terminal to a DC load connected between an output terminal and a common output terminal, or from a DC voltage source connected between said output terminal and said common output terminal to a DC load connected between said input terminal and said common input terminal said converter comprising:
an isolation transformer with a primary winding and a secondary winding, each winding having one dot-marked end and another unmarked end whereby any AC voltage applied to said primary winding of said isolation transformer induces AC voltage in said secondary winding of said isolation transformer so that two AC voltages are in phase at dot-marked ends of said primary and secondary windings of said isolation transformer;
an input inductor connected at one end to said input terminal;
a first switch with one end connected to said common input terminal and another end connected to said another end of said input inductor;
a second switch with one end connected to said another end of said input inductor;
a boost capacitor connected at one end to said common input terminal and another end connected to another end of said second switch;
an input resonant capacitor connected at one end to said another end of said input inductor;
a resonant inductor connected at one end to another end of said input resonant capacitor;
a third switch with one end connected to said output terminal;
a fourth switch with one end connected to another end of said third switch and another end connected to said common output terminal;
a first output resonant capacitor with one end connected to said output terminal;
a second output resonant capacitor with one end connected to another end of said first output resonant capacitor and another end connected to said common output terminal;
said primary winding of said isolation transformer connected at said dot-marked end to another end of said resonant inductor and said unmarked end thereof to said common input terminal;
said secondary winding of said isolation transformer connected at said dot-marked end to said another end of said third switch and said unmarked end thereof to said another end of said first output resonant capacitor;
an output capacitor with one end connected to said output terminal and another end connected to said common output terminal;
switching means for keeping said first switch and said third switch ON and said second switch and said fourth switch OFF for a duration of an ON-time interval DT_{S}, and keeping said first switch and said third switch OFF and said second switch and said fourth switch ON for a duration of an OFF-time interval D′T_{S}, where D is a duty ratio and D′ is a complementary duty ratio within one complete and constant switch operating cycle T_{S};
wherein said isolation transformer does not have a DC-bias and does not have an air-gap;
wherein said primary winding and said secondary winding are tightly coupled for reduced leakage;
wherein said first switch, said second switch, said third switch, and said fourth switch can be implemented with active semiconductor switching devices such as MOSFET transistors;
wherein said resonant inductor, said input resonant capacitor, said first output resonant capacitor, and said second output resonant capacitor form a first resonant circuit during said ON-time interval and define a constant first resonant conduction period T_{R1};
wherein said resonant inductor, said input resonant capacitor, said first output resonant capacitor, and said second output resonant capacitor form a second resonant circuit during said OFF-time interval and define a constant second resonant conduction period T_{R2};
wherein said first switch and said third switch are turned ON at zero current level and a first sinusoidal resonant current flows through said third switch until it reaches a zero current level again when said third switch is turned OFF making said first resonant conduction period T_{R1} equal to or smaller than said ON-time interval;
wherein said second switch and said fourth switch are turned ON at zero current level and a second sinusoidal resonant current flows through said fourth switch until it reaches a zero current level again when said fourth switch is turned OFF making said second resonant conduction period T_{R2} equal to or smaller than said OFF-time interval;
whereby said third switch is turned ON and turned OFF at zero current with no switching losses;
whereby said fourth switch is turned ON and turned OFF at zero current with no switching losses;
whereby an output voltage between said output terminal and said common output terminal is regulated by controlling said ON-time interval of said first switch;
whereby said converter has a step-down/step-up voltage gain characteristic when said duty ratio D is smaller than a resonant duty ratio D_{R} for which said first resonant conduction period T_{R1} is equal to said ON-time interval;
whereby said converter has a step-up voltage gain characteristic when said duty ratio D is equal or bigger than said resonant duty ratio D_{R};
whereby a turns ratio of said secondary winding to said primary winding of said isolation transformer provides additional scaling of said DC-to-DC voltage conversion ratio of said converter;
whereby voltage stresses on said third switch and said fourth switch are equal to said output voltage;
whereby voltage stresses on said first switch and said second switch are equal to said output voltage divided by said turns ratio of said isolation transformer;
whereby [symbol]
